(19) United States
(12) Patent Application Publication
(10) Pub. No.: US 2016/0034827 A1
(43) Pub. Date: Feb. 4, 2016

(54) AUTOMATED DIARY POPULATION II

(71) Applicant: AMP NEVADA LLC, Las Vegas, NV (US)

(72) Inventor: Gary Morris, London (GB)

(21) Appl. No.: 14/773,898

(22) PCT Filed: Mar. 17, 2014
(86) PCT No.: PCT/EP2014/055337

§ 371 Date: Sep. 9, 2015

(30) Foreign Application Priority Data
Mar. 15, 2013 (GB) 1304813.7

(51) Int. Cl. G06Q 10/02; G06F 3/0482; G06F 3/0488; G06F 3/0484

(52) U.S. Cl. CPC G06Q 10/02; G06F 3/04842; G06F 3/0482; G06F 3/04883

(57) ABSTRACT

The invention relates to a user device configured to automatically populate a user diary. The device includes a user interface configured to present the user with a window associated with a selection icon for selecting into the window one of a plurality of groups of connected events, each group constituting a layer. A processor is configured to execute a program which receives the user selection and generates a layer request. The layer request is transmitted to an event database from which the processor is configured to receive a response, including a group of connected events associated with the layer in the layer request. The user interface is operable to display to the user a calendar view wherein any date on the calendar on which an event in the group of connected events takes place includes a marker, preferably unique to the layer in the layer request.

### FIELD OF THE INVENTION

The present invention relates to automated diary population.

### BACKGROUND

Electronic diaries have been available for many years. They allow a user to view on a display of their user device a diary which includes appointments, etc. for a user. Appointments are entered into an electronic diary in a number of different ways. A user can enter them manually by calling up a diary page and entering text in the appropriate time and date slot.

Alternatively, diaries can be shared across a number of users in a defined user group, such that appointments of one user can automatically populate the diary of another user within the group.

Appointments received by an email service can be transferred automatically into a diary by selecting an attachment within the email. Some applications allow specific invitations to be sent by email, whereupon a user upon receipt of such an invitation merely has to select the attachment and it populates his diary automatically. British Airways offer a facility which allows a user to select that a booked flight automatically populates their diary.

The word “diary” used herein implies an electronic store into which a user can enter appointments and which can present a view of these appointments to a user on a screen of a user device.

Calendars also exist, which display to a user a view of dates, times, etc. populated by appointments. Calendar usage has been extended recently by online sharing services such as Google calendars and the iCal format where calendar views of multiple diaries can be shared.

However, developments in calendar usage thus far have been confined to updating times and dates, adding notes and inviting participants. Apart from the limited possibilities to import specialist calendar entries, there has been limited development in population of a calendar other than by user input. Where a possibility does exist to import specialist entries, the user has to accept all of the data without limitation or refinement.

It is an aim of the present invention to provide a diary and calendar with facilities for automated population with substantially reduced user input.

It is a further aim to extend the type of data for populating a diary and calendar, without placing any additional burden on a user.

### SUMMARY

One aspect of the present invention provides a user device configured to automatically populate a user diary, the device comprising:
a user interface configured to present to a user a window associated with a selection icon for selecting into the window one of a plurality of groups of connected events, each group constituting a layer;
a processor configured to execute a program which receives the user selection and generates a layer request;
means for transmitting the layer request to an event database;
the processor configured to receive a response from the event database including a group of connected events associated with the layer in the layer request; and
the UI operable to display to a user a calendar view wherein any date on the calendar on which an event in the group of connected events takes place includes a marker, preferably unique to the layer in the layer request.

In one embodiment of the present invention the layer is a group of public holidays corrected by a common parameter.

In another embodiment of the present invention the marker is a coloured icon and each layer is represented by a unique colour, preferably wherein the colour is selected by the user.

A second aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
wherein the UI is operable to display to the logged in user an agenda bar at a fixed location on a screen of the UI, the agenda bar when expanded providing on the screen a sequence of upcoming events selected by the logged in user.

The user device can comprise means for a user to enter a personal event into the diary.

The agenda bar also can be expanded to show a sequence of events horizontally.

The user interface can be operable to present to a user a modal entry window for entering details of personal event for populating the diary, the modal entry window presenting fields for population corresponding to fields holding event data in the event database.

The processor of the user device can be configured to execute a program which generates a request identifying a date, the request being transmitted to the event database; the user device can also comprise a means for receiving from the event database event data corresponding to the selected date; and the user interface can be configured to present to a user event information based on the event data for the selected date so as to permit a user to select at least one event for populating the user diary, whereby selection of the event by the user automatically imports the event to the diary, by updating stored diary data.

The user device can comprising means for a user to enter a personal event into the diary wherein the user interface is operable to display to a user a calendar view, wherein any date on the calendar on which a selected event takes place includes a marker for personal events differs from that for database events and layer events.

A third aspect of the present invention provides a computer system for managing event data comprising:
a database storing event data relating to a plurality of events, each event associated with an event date and a layer identifier;
a handling function for receiving a layer request from a user terminal;
the request including at least a layer identifier;
a filter function for returning event information corresponding to the date in the request, the filter function event data based on the layer identifier to return a group of events associated with the layer identifier.

A fourth aspect of the present invention provides a computer system for managing event data comprising:
a database storing event data relating to a plurality of events, each event associated with an event date;
a handling function for receiving a request from a user terminal;
the request including at least a user identifier, a date and a search refinement criteria;
a filter function for returning event information corresponding to the date in the request;
wherein the handler function is operable to supply the request to the filter function for accessing the database, the filter function operable to return events based on the user identifier and any search parameters supplied in the request, and to return events based on the user identifier where no search parameters are supplied in the request; and
a crawler function for managing a plurality of web crawlers for automatically detecting a venue address for an event, determining a website address associated with the event based on said venue address, generating a crawler to crawl for events from the associated website address, and populating the database with event data relating to a plurality of events crawled from the associated website address.

A fifth aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
wherein when the user performs a side-swipe action on information for one event presented on the user-interface, the screen of the user-interface displays at least one of:
a user-selectable “add to calendar” button; and
a user-selectable “buy tickets” button.

A sixth aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
wherein the user interface enables the user to enter a search parameter and wherein the event data is received as a group of events sharing a common criteria defined by the search parameter, the user interface configured to display the group as a stack wherein a single image is visible with a user selectable icon for selecting the display of all the events in the group;
wherein the user interface displays a user selectable “add” button for each of the displayed events in the group, any one or more of the “add” buttons being selectable by the user so as to select one or more of the corresponding events in the group; and
a user selectable “add selected events” button is then selectable by the user so as to simultaneously add the selected events in the group to the user diary.

A seventh aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
a geo-location device for automatically locating the user; and
wherein the user interface displays event information for events that are nearest to the user's current position.

An eighth aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
a geo-location device for automatically locating the user; and
wherein the user interface displays event information for events that are within a pre-defined radius of the user's current position.

A ninth aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
a geo-location device for automatically locating the user; and
wherein the event information displays for each event how far away the respective event location is from the user's current position.

A tenth aspect of the present invention provides a computer system for managing event data comprising:
a database storing event data relating to a plurality of events, each event associated with an event date;
a handling function for receiving a request from a user terminal;
the request including at least a user identifier, a date and a search refinement criteria;
a filter function for returning event information corresponding to the date in the request;
wherein the handler function is operable to supply the request to the filter function for accessing the database, the filter function operable to return events based on the user identifier and any search parameters supplied in the request, and to return events based on the user identifier where no search parameters are supplied in the request;
a clash notification means arranged to issue a warning message to a user on an attempt to update a diary with an event which clashes with an existing event in the diary, wherein the warning is issued based on the location for the event attempting to update the diary in respect of the location of the existing event in the diary, wherein the clash event notification means determines that there will not be time for the user to get from the location of the existing event in the diary to the location for the event attempting to update the dairy.

An eleventh aspect of the present invention provides a computer system for managing event data comprising:
a database storing event data relating to a plurality of events, each event associated with an event date;
a handling function for receiving a request from a user terminal;
the request including at least a user identifier, a date and a search refinement criteria;
a filter function for returning event information corresponding to the date in the request;
wherein the handler function is operable to supply the request to the filter function for accessing the database, the filter function operable to return events based on the user identifier and any search parameters supplied in the request, and to return events based on the user identifier where no search parameters are supplied in the request;
a clash notification means arranged to issue a reminder to a user based on the user's current position in respect of the location of an upcoming event in a user diary.

A twelfth aspect of the present invention provides computer system for managing event data comprising:
a database storing event data relating to a plurality of events, each event associated with an event date;
a handling function for receiving a request from a user terminal;
the request including at least a user identifier, a date and a search refinement criteria;
a filter function for returning event information corresponding to the date in the request;
wherein the handler function is operable to supply the request to the filter function for accessing the database, the filter function operable to return events based on the user identifier and any search parameters supplied in the request, and to return events based on the user identifier where no search parameters are supplied in the request;
a typing prediction means arranged to predict potential events as search terms are input by a user at the user terminal wherein potential events are displayed in a modal window; and
wherein the typing prediction means further predicts up to three other types of results, whereby the potential events and results are displayed in the modal window separated under up to four headings.

A thirteenth aspect of the present invention provides a user device configured to automatically populate a user diary, the device comprising:
a processor configured to execute a program that generates a calendar selection message comprising a user identifier and selection information for subscribing to a themed calendar for said user;
means for transmitting the calendar selection message to a diary function of a computer system;
a user interface configured to automatically present to the user a user diary stored at the diary function and populated with events corresponding to a class of events associated with the themed calendar the user has subscribed to.

A fourteenth aspect of the present invention provides a computer system for managing event data comprising:
a database storing event data relating to a plurality of events;
a diary function receiving a calendar selection message from a user terminal; the calendar selection message including at least a user identifier and selection information for subscribing to a themed calendar for said user;
wherein the diary function stores a user diary associated with the user, and the user identifier allocates the calendar selection message to the user diary associated with the user; and based on event data from the database, an update function populates the user diary with events corresponding to a class of events associated with the themed calendar the user has subscribed to.

Our related application PCT/EP2012/069542 provides the following additional aspects of the invention which can be used in combination with the novel concepts discussed herein.

One aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user event information based on the event data for the selected date so as to permit a user to select at least one event for populating the user diary, whereby selection of the event by the user automatically imports the event to the diary, by updating stored diary data.

Event data can be refined prior to populating the diary. Embodiments of the invention further provide API's to allow any website to provide event information in a format which can be imported directly into the user's diary.

The date in the request can be automatically determined as the present day, recognised by the user terminal or, alternatively, can be selected by a user using a calendar displayed to him.

The user device can take the form of any user terminal such as a personal computer, cell phone, tablet, personal entertainment device, games console or Smart mobile device.

The invention also provides a computer system including a user device and a database storing event data relating to a plurality of events and operable to receive a request from the user terminal and return event information corresponding to the request.

The database can be accessible to the device via a server system. The server system can be arranged to filter event data based on user preferences and/or characteristics prior to returning event information responsive to the request.

The server can be accessed by the user terminal via a network such as the Internet, with the user terminal having uploaded a web browser capable of delivering the functionality claimed herein. This is the case for a web-based application of the calendar service. Alternatively, a mobile version of the calendar service can be made available as an APP through a wireless portal contactable to the server system via a wireless network.

The invention also provides a computer system for managing event data comprising:
a database storing event data relating to a plurality of events, each event associated with an event date;
a handling function for receiving a request from a user terminal;
the request including at least a user identifier, a date and a search refinement criteria;
a filter function for returning event information corresponding to the date in the request, the filter function filtering event data based on characteristics associated with the user identifier, wherein the filter function is operable to filter events based on a history of events selected by a user making the request; and
wherein the handler function is operable to supply the request to the filter function for accessing the database, the filter function operable to return events based on the user identifier and any search parameters supplied in the request, and to return events based on the user identifier where no search parameters are supplied in the request.

A “history” button can be provided so that a user can select a date in the past to see if anything of interest has happened on that date.

According to one embodiment of the invention, the database includes events data associated with a category identifier and date identifier. Thus, the principle organisation of the event data can be by category, but associated with any particular date. This provides a first level of filter for displaying information to a user.

Filtering can be carried out by the server system. User preferences can be determined from a user via the user terminal. User characteristics can be obtained from a user profile used by the user in other networks, for example, social networks.

User characteristics can identify one or more user's network and other users “connected” in these networks, whereby the navigation history of the user and/or his connected users can be taken into account when filtering events to be recommended to the user.

Events can be searched by a user who can enter search parameters of the user terminal. In that case, the server system can receive the search parameters and return event data based on those search parameters. The search function provides a useful tool for a user separate or in addition to the filtering function.

One specific search parameter which can be used is a location parameter. To that end, the user device can include means for receiving a location indicator in the request which is supplied to the database. The location indicator can be derived automatically from the user terminal, for example, using a GPS location device at the user terminal, or can be entered by a user who can, for example, click on a country icon. To allow event data to be searched by location, event data can be held in the database in association with the location identifier. Multiple locations can be selected allowing the user to build/view an International itinerary. Public Holidays at a location can automatically update the calendar/diary.

Major national events such as Halloween/Valentines Day can automatically be updated into the calendar/diary.

Another search parameter can define an artist or venue, and the search can be configured to return a set of events grouped by a common criteria, such as artist. These can be displayed to a user in a “stack”, wherein a single event image is visible with a user selectable icon for selecting the display of all events in the group.

The invention further provides a computer system comprising:
a database storing event data relating to a plurality of events, each event associated with an event date;
a handling function for receiving a request from a user terminal;
the request including a user identifier and a date; and
a filter function for returning event information corresponding to the date in the request, the filter function filtering event data based on characteristics associated with the user identifier.

The invention further provides a server system for managing event data, the server system comprising:
a handler function for receiving a request from a user terminal, the request including a location identifier identifying a location of the user terminal;
a diary update function operable to update a user diary with a class of event data relating to the location identified in the location identifier.

The invention further provides a computer program product, comprising program code means which when executed on a computer at a user device implement the following steps:
generate a request identifying a date;
cause a request to be transmitted to an event database;
receive from the event database event data corresponding to the selected date;
present on a user interface event information based on the event data for the selected date so as to permit a user to select at least one event for populating a user diary, whereby selection of the event by the user automatically imports the event to the diary, by updating stored diary data.

The invention further provides a computer program product comprising program code means which when executed on a computer implement the following steps:
receive a request from a user terminal, the request including a user identifier and a date;
access an event database for event information associated with events; and
filter the event data based on characteristics associated with the user identifier to return event information corresponding to the date in the request after said filtering.

The invention further provides a computer program product comprising program code means which when executed on a computer implement the following steps:
receiving a diary update message from a user terminal, the diary update message including a user identifier and an event identifier identifying an event selected by a user at the user terminal; and
importing event data of the event identified by the event identifier into a personal diary associated with the user identified by the user identifier.

The invention further provides a computer program product in the form of an application programming interface, comprising program code arranged to receive information defining an event from an event source and to transform the event information into event data in a format suitable for loading into an event database.

The invention further provides a server system for updating a user diary, the system comprising:
a diary function operable to receive a diary update message identifying an event and to update the user diary with event data of the identified event; and
an update function configured to detect changes in event data stored in an event database and to generate a diary update message to automatically update the user diary with the changed event data.

The personal diary to be updated by the event data can be provided in the server system with the filtering function, or it can be a separate diary which receives an update message in a suitable format for updating the diary. For example, an existing calendar such as iCal can be updated with event data in accordance with an embodiment of the present invention.

Push notification/reminders can be provided of events listed in a personal diary or events that may be of interest to a user.

Clash event notifications can be provided such that a user gets a modal warning if attempting to add an event or diary event in the same time frame as an existing event Embodiments of the invention can provide the ability to create an open diary which can be read widely; the writer being the author and the reader being the user. The user's diary is updated and populated with diary data from the author.

Embodiments of the invention can further provide the ability for the user to enter their own diary data to include a postcode; entry of such postcode allows the user to automatically view the event position on a map.

In addition to the architectural and structural search and filtering features for events discussed above, the following embodiments describe a number of ways of presenting event information to a user which simplifies management of a personal diary calendar for the user.

The invention also provides in a further aspect, a user device configured to automatically copulate a user diary, the device comprising:
a processor configured to execute a program which generates a request identifying a search parameter;
means for transmitting the request to an event database;
means for receiving from the event database event data corresponding to the selected search parameter, wherein the event data is received as a group of events sharing a common criteria defined by the search parameter;
a user interface configure to present to a user event information based on the event data wherein the group of events is displayed as a stack wherein a single event image is visible with a user selectable icon for selecting the display of event images of all of the events in the group.

The invention also provides in a further aspect, a computer system for managing event data comprising:
a database storing event data relating to a plurality of event, each event associated with an event date;
a recommendation and ranking function for supplying event information to a user terminal for display to a user;
a diary function operable to receive data from an event selected by a user and update a user's diary based on the event data;
wherein the recommendation and ranking function is operable to determine which events a user has selected to populate his diary and to locate at least one event in the database that is similar to events which the user has used to populate his diary whereby the at least one event can be supplied to the user as a recommendation.

For a better understanding of the present invention and to show how the same may be carried into effect reference will now be made to the accompanying drawings.

### BRIEF DESCRIPTION OF THE DRAWINGS

FIG. 1 is a schematic block diagram of a technical platform for implementing an electronic diary and calendar population service;

FIG. 2 is a screen shot of a home page of the service;

FIG. 3 shows expansion of the screen shot into various diary views;

FIGS. 4A-4C show the diary population service implemented on a mobile device to describe a search function of the service;

FIG. 5 is an architectural block diagram of a user terminal for implementing the service;

FIG. 6 is a schematic diagram showing message flow;

FIGS. 7A to 7C are illustrations of the user interface implementing a stack function;

FIG. 8 shows the format of an event entry in the database.

FIG. 9 is a schematic diagram illustrating the cooperation between a data structure for the event data and a data structure for the diary function;

FIG. 10 is a screen shot of an event view page of the service;

FIGS. 11A to 11D illustrate how Layers are added to the calendar function;

FIGS. 12 to 12C are screen shots of a calendar view of the service and of the displayed Agenda Bar;

FIG. 13 is a screen shot of a calendar view of the service generated by the clicking an Actuatable “today's date” control in the My Agenda tab;

FIGS. 14A to 14B are screen shots of when the Agenda Bar is empty and when the Agenda Bar is hidden/closed.

### DETAILED DESCRIPTION OF PREFERRED EMBODIMENTS

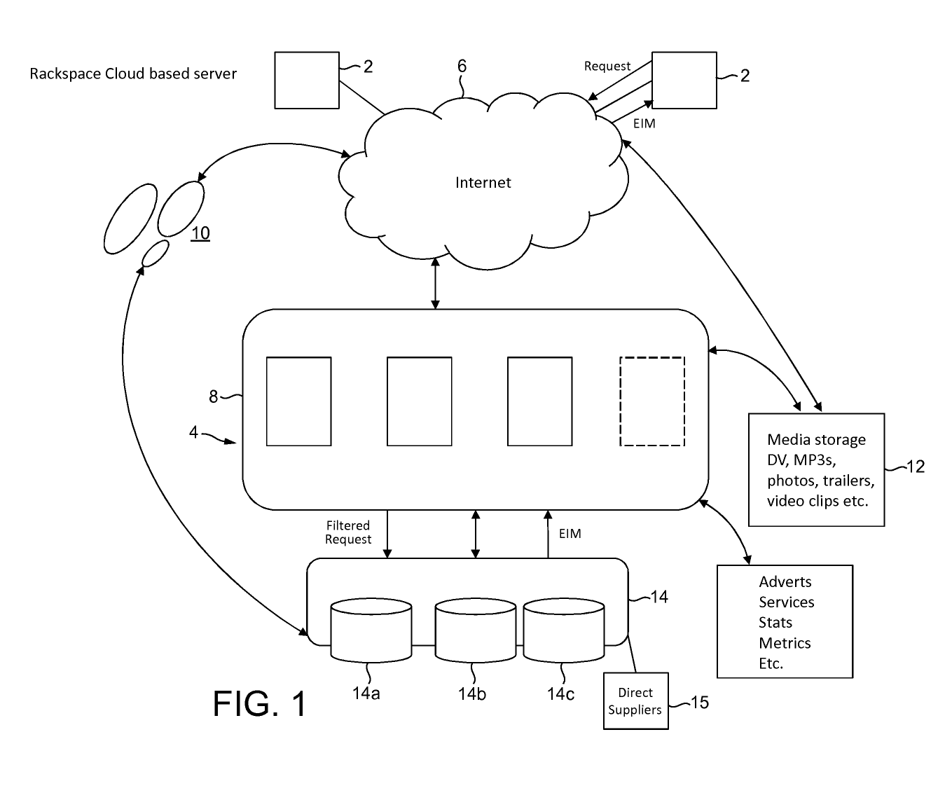

FIG. 1 is a schematic diagram of an architectural platform for supporting a calendar service. The platform of FIG. 1 is web-based. That is, the calendar service is available through standard browsers on a plurality of user terminals connected to the Internet. It will be appreciated that there will be a very large number of user terminals extending globally, but two are shown in FIG. 1 by way of example. The user terminals 2 are connected to a central server system 4 by way of a network such as the Internet 6. The server system can comprise a distributed collection of web servers 8, a system 10 for managing a plurality of web crawlers and a distributed media server 12. A database 14 is connected to the server system 4. The database can be managed by a distributed database server (for example, a sequel server) in the server system 4.

The web servers 8 serve primary front end web requests which are received via the Internet 6 from the user terminals 2. The database 14 serves the data storage and search needs of the population service, and is accessed by the web servers 8 and the system 10 managing the crawler services. In particular, the database 14 holds event data in a data format for allowing events to be displayed at the user terminals 2.

The function of the crawler services 10 is to crawl the Internet 6 to locate the sources of events and grab information about those events for supply to the database 14. Crawler services are known per se, and can run on a server instance and deposit fetched data into the database 14. In the present case, the crawlers are focussed on locating event data from event data sources. The crawler services extract information from websites providing events and convert the information into a data format for storage in the database.

Event data is also supplied to the database through the Application Programming interfaces (API's) made available to event suppliers. The API's provide data to the database in the data format.

Another source of event data is an open diary having an author who enters his appointment in the diary—for example the author can be a celebrity.

The media server 12 can store and supply large, static content, when appropriate, such as images and videos. That is, the event data can include a pointer to media content, e.g. a video, to be displayed with the event information. For example, video content can play from sponsor's servers.

The event data is accessible through the instances of the population service running in browsers of the user terminals so as to automatically populate a personal user diary which is available to a user at his terminal.

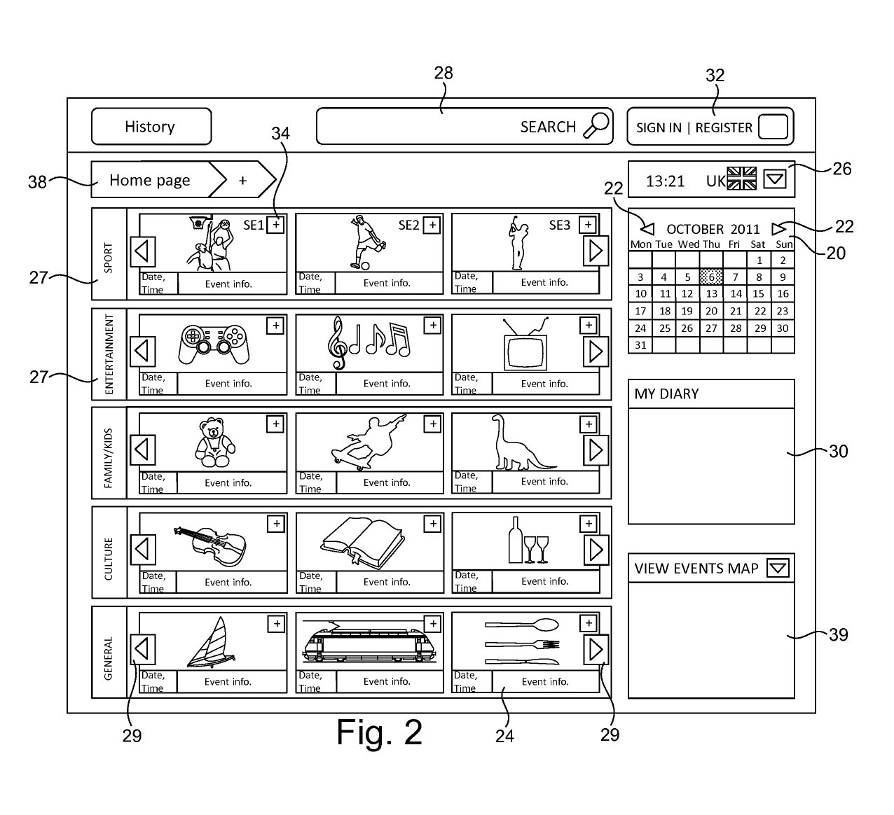

FIG. 2 shows a schematic diagram of a home page displayed to a user at his user terminal 2 when he enters the website address for the service using his web browser. Page shows a calendar 20 for the current month, displaying the current date highlighted. A user can change month by activating the arrows 22 by activating his user interface control, for example, keyboard, mouse and cursor, touch screen or in any other way. In the illustrated example, the date 6 Oct. 2011 is highlighted in the calendar 20. Located to the left of the calendar is an event display portion 24. The event display portion can take a number of different display configurations as discussed more fully in the following, but on the home page illustrates a set of events in each of a number of different categories, for example, as shown in FIG. 2, sport, entertainment, family/kids, culture and general. In each category, a set of individual events is displayed which take place on the highlighted day 6 Oct. 2011. For example, in the category of sport, sport events SE1, SE2, SE3 are shown in adjacent display portions, each display portion having an image so that the user can readily identify the nature of the sport event, a date portion with the date of the event and a text portion describing details about the event. Event information displayed in other categories has a similar format. The event information which is displayed to a user pertains to the date selected by the user in the calendar 20. When the home page is launched, the display defaults to the current date, which is highlighted. However, a user can change the date with his user interface control (user input device) and when he selects a different date, event information for that date is automatically displayed to him.

This is achieved in the following way. When the user selects a date on the calendar 20, a request is transmitted from the user terminal 2 via the Internet 6 to the server system 8 for event information related to that date. The event information for the relevant date is retrieved by the server system 8 from the database 14, which holds event data which has been uploaded to the database 14. The relevant event information is returned in the form of an event information message (EIM) via the server system 8 and the Internet 6 to the user terminal 2 that requested that particular date. In one embodiment, on the user display the selected date is shown in yellow highlight, while the current day is shown in a grey highlight. As the user navigates away from the current month using the arrows 22, a memory retains data identifying the current day such that the user can automatically recover current day information.

The event information can be retrieved from one or more database servers. Three database servers 14a, 14b, 14c are shown in FIG. 1. The database server 14a holds information about events in the United Kingdom, the database server 14b holds information about events in the USA and the database server 14c holds information about events in Europe. It will be appreciated that the principle can be extended to any number of geographical locations, organised by country or in any other way. The database which returns the event information for display to a user can be selected in a number of different ways. The user interface illustrated in FIG. 2 shows a country flag 26 associated with a drop-down menu from which a user can select one or more of a number of different countries, but only selecting one country at a time. When a country has been selected, the request which is transmitted from the user terminal 2 contains information about that country which redirects the request to the correct country specific domain. Although illustrated as separate servers, it will be appreciated that any implementation of country specific domain is possible.

Alternatively, automatic location of the user can be accomplished and this location information is incorporated into the request from the user terminal each time a request is transmitted from that user terminal. The location can be determines automatically by using a built-in GPS or other geo location function in the web browser of the user terminal, or by considering IP address information or using cookies or in any other way. If the user location is provided automatically, a function can be provided to a user to allow him to override it and choose another location.

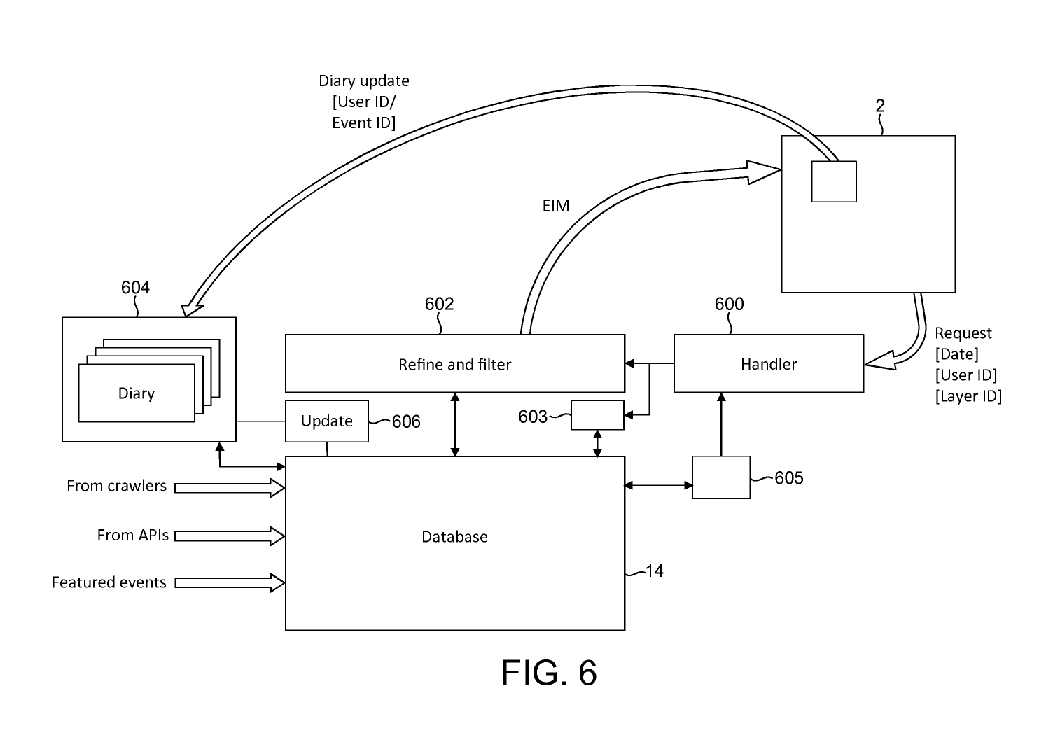

The population service incorporates a search tool 603 (FIG. 6) which provides a text box 28 to a user. A user can search by keyword, word or phrase to locate events of interest. Advance search options are also possible, for example, if a user wants to view pop concerts for five days from 21 October, then in advance they can enter words, categories and dates ahead of that date.

If a user is interested only in one of the categories displayed to him, he can select that category, for example, by using a mouse and cursor to click on the category tab 27 associated with the event whereupon all events displayed to the user are in the selected category. Scroll arrows 29 are provided in each category to allow a user to scroll within the category. A plurality of events are available from the database for each date in each category, not all of which may be able to be shown on the display at the same time.

The display provides an event map 39 which shows the location of an event on a display when the user selects the event, for example by clicking on it.

Event information supplied to a user can be refined by characteristics associated with the user. These can be shared with a user identifier at the server system, along with user preferences and user event selection history.

One such characteristic can be the name of an author of an open diary, for example a celebrity. In that case, the celebrity's appointments/events are shown to the user.

Thus, filtered and organised events can be displayed to a user in association with his calendar.

The automated diary and calendar population function will now be described. In FIG. 2, reference numeral 30 illustrates a user diary. In order to see or access their diary, a user must register or be signed in. This provides a user identifier associated with the user. A sign-in and registration box 32 is provided to the user for this purpose. If a user sees an event that they would like to attend, they can add it to their diary simply by actuating an add button 34 which is associated with each event. It will be appreciated that the add button could take any form and could in fact be omitted in place of a function where a user could actuate the event information itself displayed to the user, for example, by actuating the image, date portion or text portion or the entire footfall of the event image.

Following a search for a particular category or micro category, a user may determine that all events displayed to him as a result of the search are relevant and can select an “add all” function to add them all into his diary.

An automatic update feature can be provided for selection by a user. According to this feature, a class of events can be preselected by a user which automatically populate the user diary without the user having to take any action. For example, an open (e.g. celebrity) diary can be selected by a user to automatically populate their personal diary with celebrity events.

When a user has selected an event to populate his diary, a marker appears on that date in the calendar 20 to indicate that the user has an event on that date.

A user can also input to the diary personal dates with information and explanation that the user can provide. These can also be marked in the calendar.

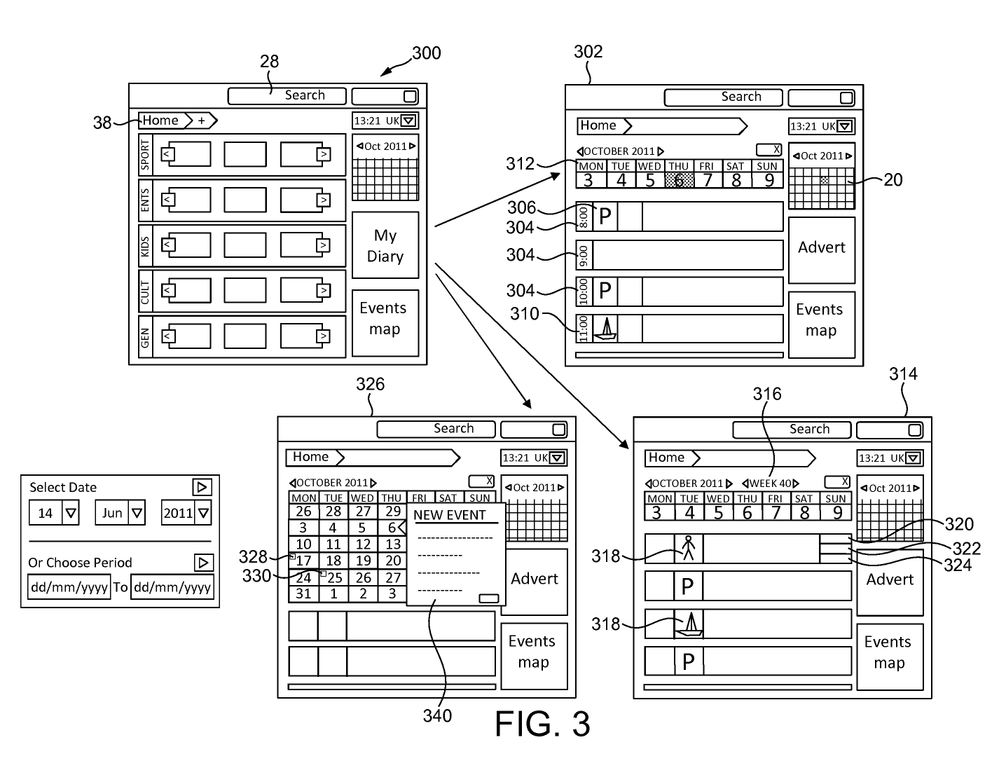

FIG. 3 illustrates different views of the calendar and diary function provided by the calendar service. Reference numeral 300 denotes the home page which has been described in more detail already with respect to FIG. 2. In addition to the search box 28, events can be displayed to a user in a number of different formats. The different formats can be selected by selecting different modes using the bar 38. Reference numeral 302 denotes a selection of day mode using the bar 38. In day mode, the events entered into the user diary for that day are shown. The diary is divided into time slices 304 with each time slide being populated by an event or not depending on the selections which have been made by the user previously. Events can be personal, and can be represented by a specific personal icon 306 or they can be stored events from the event database 14, for example event 310. Events from the database can be recognised by carrying an image representative for the event as in the image portion described above with reference to FIG. 2.

In day mode, it is possible to activate (for example, by single clicking) any day which is illustrated on the day bar 312 to make an entry into the diary on that activated date. An entry portal is opened which is described later.

The time slices can be any size but typically they may be one hour slots. It is likely that a user will not have an event every hour.

A user can activate a time slice, for example, by clicking, to enter an event into that time slice, by opening an entry portal.

The calendar 20 is visible in day mode and can be used to look at dates without changing the diary view. If a user activates a date in the calendar, the diary view will update to that date.

Reference numeral 314 denotes the diary view presented to a user when week mode has been selected at bar 38. In week mode, the week number in the year is displayed as shown at 316. As with the day mode, activating any day which is visible in that week allows an entry to be made into the diary on that activated date.

Furthermore, as with the day mode, events in the event database can be easily recognised by the image associated with the event as in the image portion. This is denoted by reference numeral 318 for two of the events. Personal events are recognisable by the personal icon 306. It is noted that users can personalise their personal icon for each event by uploading an image or photo to replace the generic icon.

Each event is associated with a set of functions 320 to 324. Although not described with reference to day mode (and month mode which follows), these functions are available in all modes. The share mode 320 allows a user to share the event with others, for example, by emailing it.

The remove function 322 allows a user to delete the event from the diary. The edit function 324 allows a user to alter aspects of the event, provided that it is a personal event. It is noted that a limited edit function is available for events from the event database so that a user can edit all information but the edited information is only visible to them. They cannot share the edited event. This is done in case they wish to add time handles or if crawled data in the database is incomplete. Reference numeral 326 denotes the diary view in month mode as selected by bar 38. In the monthly mode, a single month is shown in full, with events marked against days of the month. An event from the event database can be marked with a dot of a first colour, for example, yellow and personal events can be marked with a different colour dot, for example, grey. By way of example, a personal mark 328 is shown against 17 October, and a database event mark 330 is shown against 25 October.

The monthly view 326 shows a modal entry window 340 which can be used to enter a new personal event. The modal entry window 340 can be provided to a user on actuation of a selected date in any of the monthly, weekly or day views. The modal entry window 340 includes a plurality of fields including:
Location, time of event, diary status, alarm, invitees, attachments, URL and note.

By entering appropriate details into these fields, a user can add a personal event to the diary. A postcode field can be provided. If a postcode is entered, the location of the event is shown on the events map 39.

The fields for entering the personal event can match the fields for event data in the database. Data entered into a personal event entry window can be supplied to the search function 603 to allow a search to be carried out using that data.

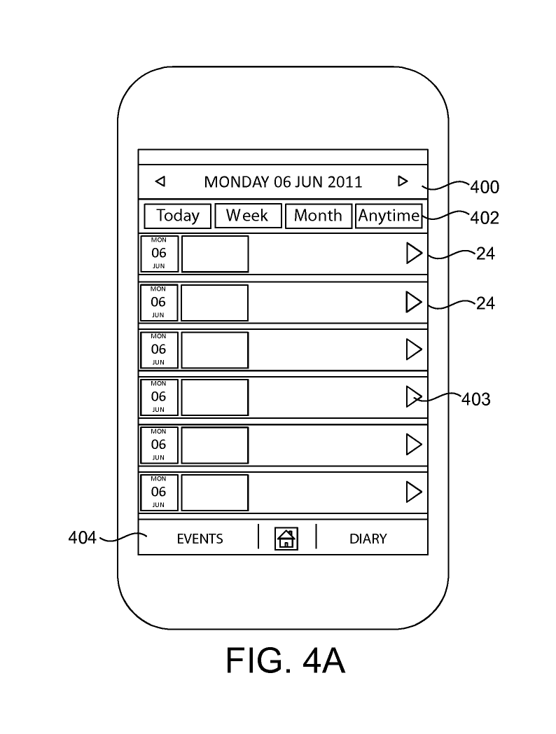

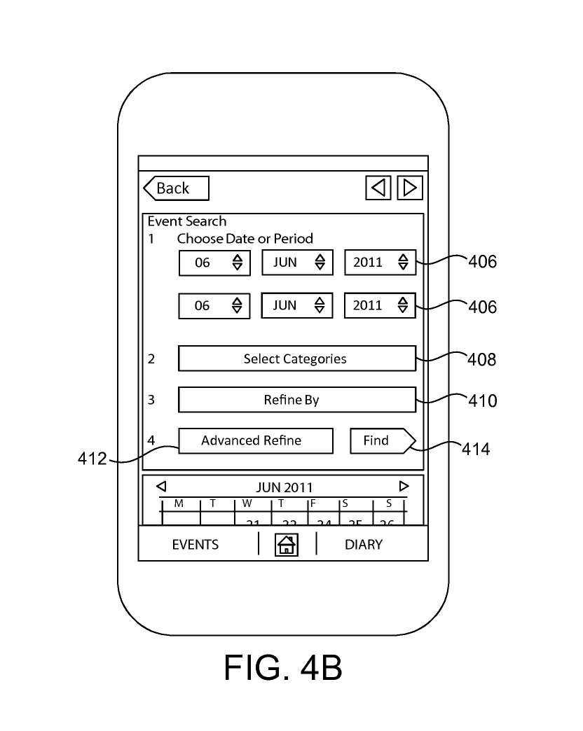

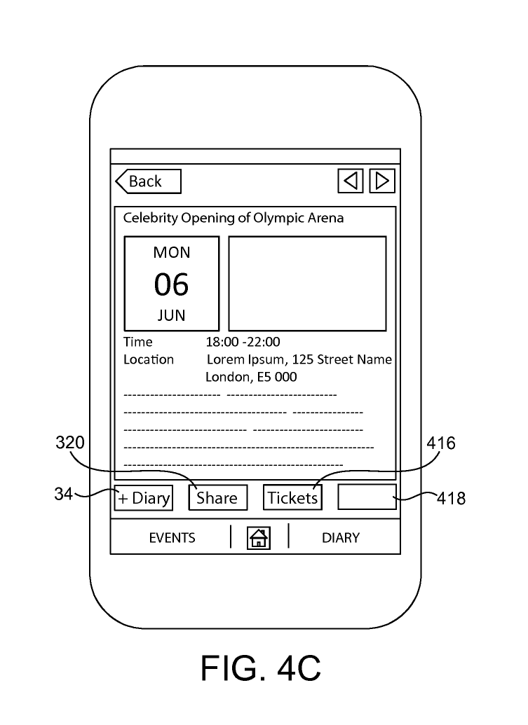

Reference will now be made to FIGS. 4A to 4C to describe the search function for database events in more detail. FIGS. 4A to 4C illustrate a user interface on a user terminal in the form of a mobile device such as a smart phone. It will readily be appreciated that the concepts described above with respect to a web-based user terminal can be applied on a mobile device implemented as an APP, while the search concepts which are about to be discussed with reference to the mobile device can similarly be applied to any type of user terminal. The particular display configurations are given here by way of example only and are not intended to be limiting.

FIG. 4A illustrates the home page of an event service suitable for a mobile device. Reference numerals are used to denote the same items as on the home page illustrated in FIG. 2, although the display configuration is different. The current date 400 is displayed at the top of the screen. A user has the ability to flick forward and backward day by day using arrows on the right and left of the date 400. Four quick searches are made available by reference numeral 402. These searches include “what's on today”, “what's on tomorrow”, “what's on this week”, and “what's on this month”. Each search, when activated, shows a set of events in display portions 24 for that day, week or month which can be scrolled through. The fourth quick search is activated through the “anytime” button. This button accesses an event search page. This event search page can also be accessed from an events button 404. The event search page is shown in more detail in FIG. 4B. A date or period can be entered by using the date fields 406. A select categories field 408 allows a user to access a categories list.

A “refine by” field 410 allows a search to be refined in a number of different ways, for example, by city within the UK, by country, by most popular, by top ten, by category or by recently added.

An optional advanced refine field 412 allows further refinements of the search, for example, by just added, alphabetical event A-Z, alphabetical event Z-A, date nearest, date furthest, category, randomised, UK location (top twenty cities), international (twenty countries), most popular venue indoor, venue outdoor.

A find button 414 instigates the search by sending a request to the server system 8 and consequently the database 14 for events which match the search criteria. These events are returned to the device for display to a user.

FIG. 4C illustrates a display page which can be made visible to a user by actuating a detailed page icon 403 which is associated with each event, and illustrated in FIG. 4A. The display page shows details of a single event, with the image portion, date portion and text portion as already described with reference to FIG. 2. A share function 320 associated with the event allows the event to be shared with friends. The event has an add button 34 for adding the event to a user's diary. When the add button is activated, the event automatically populates the user diary. A tickets function 416 is highlighted if tickets to the displayed event are available. The ticket function 416 can display contact details for ticket sellers or provide a direct link to an affiliate ticket seller's page. A category box 418 allows a user to see a list page of other related events within the same category.

Instead of actuating the detailed page icon 403 to access a display page of a single event as described above, the user may side-swipe a particular event shown displayed in FIG. 4A. The side-swipe action causes the user's device to display a user selectable “add to calendar” button and a “buy ticket” button; the user can select the “add to calendar” button to directly add the event to his diary (or calendar) and/or to one or more shared calendars. The user can select the “buy tickets button” so that he is presented with at least one of the following: a ticket sales webpage of the service, contact details for one or more affiliate ticket seller, and an affiliate ticket seller's website.

One issue which can arise with display of information to a user is that too much information or the wrong type of information is displayed to a user, which can be off-putting and difficult for a user to manipulate. This can be managed in a number of different ways.

According to one option, a user will be provided with a mechanism for inputting a preference as to how their display should be populated with event information. For example, they could prefer that they only receive events for times after 5:00 in the afternoon or weekends, for example. Alternatively, they could express a preference for events to be filtered on any of the refine options in the search (for example, as described above with reference to FIG. 4B).

Whether or not a user expresses a preference, events can be filtered by the server system 8 which extracts events from the database for supply to the user terminals.

The system can filter for events that happen in the future, which match user preferences with categories chosen and search options by time slot, and displayed by day, week or month. The server system 8 could be operable to extract information from social networking sites associated with the user to determine a user profile, such that events appropriate to that user are displayed to them.

As one specific example of this, age range identification would allow content and event filtering, while geo location services could be used to find current location, especially for use with mobile devices.

The database 14 of events is organised by category. In addition to crawlers 10 supplying events to the database, scrapers could also be used or the database could have direct feeds (through API's) from explicit suppliers such as aggregators and ticketing service suppliers. These are denoted by block 15 in FIG. 1. Open diaries can also be provided.

Location services support zip code and post code for an “around me” style of event reporting. That is, each event in the database is associated with a location identifier which can be used as a search tag if location information is supplied from a user terminal in the search. The location identifier can also be used to display the location of the event on the event map 39. The event map 39 shows the locations of events as event markers (or virtual pins) displayed on the map. In one embodiment, when a user positions the mouse cursor over an event marker on the map when viewing the event search page, the corresponding displayed event associated with that event marker is highlighted. For example the highlighting may show that event in a different colour to any other displayed events in the event search page.

It will be appreciated that each of the search parameters described above with reference to FIG. 4B can be implemented as a tab against event data for a particular event in the database.

Users can create a “most popular” listed ranking of events so that less popular events will be aged and eventually culled based on age.

A possibility exists to allow sponsored events to be hardwired to appear at the top of listings. That is, a certain type of event (sponsored) will be marked in the database with a tab which overrides other search criteria but which still nevertheless falls within the user search parameters of date and category.

After a user has used the event service for some while, it is possible to determine which events the user has used to populate his diary, and thus determine the set of events that the user likes. Then, a group of events can be located in the database that is similar to the set of events known to be liked by the user and these events can be ranked and recommended to the user. In that case, it would not be necessary for a user to enter search criteria—instead when he opened his calendar at a certain day the group of events similar to those he has liked in the past, duly ranked would appear to him. The recommendation and ranking function (605 in FIG. 6) is carried out by an algorithm executed at the server system which runs on the data in the database.

The recommendation function will now be described in more detail.

The recommendation function is based on a hybrid method combining collaborative and content-based filtering methods.

### Collaborative Filtering

The Collaborative filtering used is a variant of item-to-item collaborative filtering to recommend based on user history. Information is retained (for example a store of the diary function 604) about all events the user has added to diary and those he visited if he has not added to diary enough events.

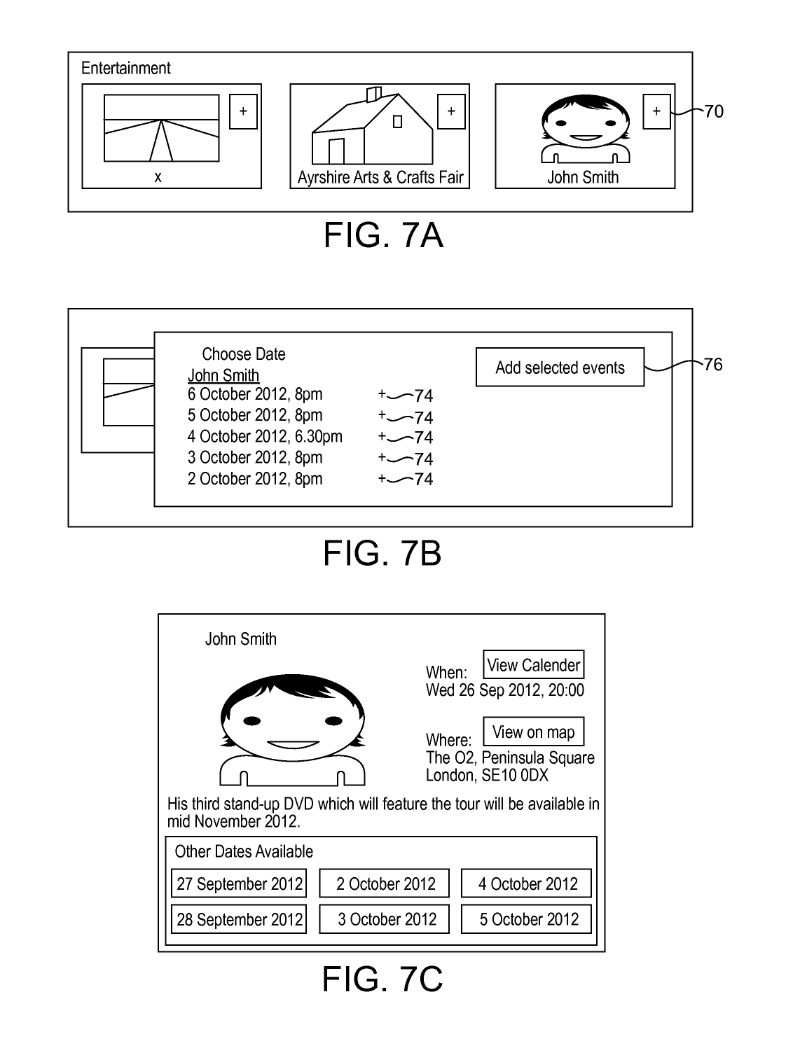

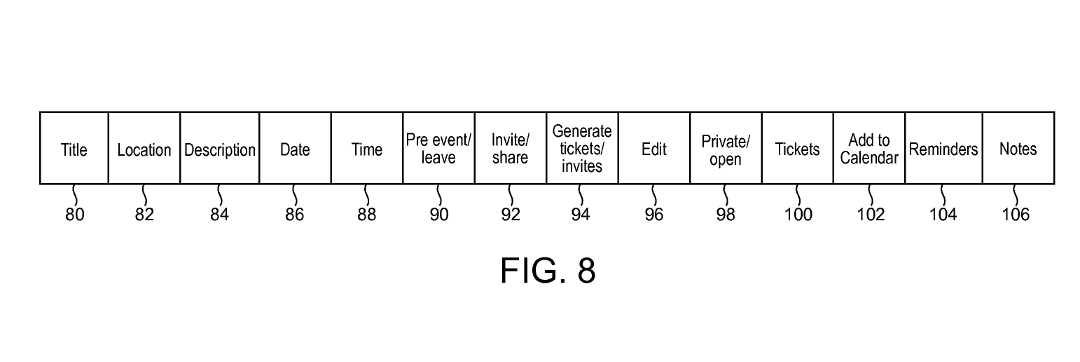

FIG. 8 illustrates the format of an event entry in the event database 14, in accordance with the embodiment. It is not necessary for each event to have all of these fields populated, but they are all available if there is data to populate them. However, certain fields are a prerequisite for efficient searching and/or recommendation features. The event entry comprises a title field 80 which holds the title of the event—this could include, for example, an artist name such as John Smith or an event title such as Ayrshire Arts & Crafts Fair (see FIG. 7A). Reference numeral 82 denotes a location field which holds a location of the event. Reference numeral 106 denotes a notes field which includes any notes a user has made concerning the event. Reference numeral 84 denotes an event description field. When searching for similar events, as described below, it is fields 80, 82, 84, 86, 88 and 106 which are taken into account.

The event entry also includes a date field 86, a time field 88, a pre-event time/leave time field 90. The event entry also includes an invite/share field 92 which defines how the event is to be shared by the user, for example, with other users connected to the user in social networks. The event entry includes a generate tickets/invites field 94, an edit field 96 and a field 98 which indicates the status of the event whether private or open when it is to be incorporated into a shared calendar. The event entry includes a ticket field 100, an add to calendar field 102 and a reminders field 104.

The add to calendar field 102 is updated when a user has selected the event so that it populates the user diary.

In another embodiment, the event data is separated from event date data in accordance with the following:

### Event

name
description
venue
url—url it was grabbed
slug
geohash (latitude, longitude in fact)
featured_flag
affiliate_flag
ranking—boosting ranking
click_ranking—ranking counted from clicks and boost
hidden_flag
clicks—how many times events was visited
owner—if it is users' event—points to user
private—if event is publicly visible
all different image size fields+link to original image
tags—categories of event
crawler—crawler that grabbed this event

### Event Date:

event—points to event
start—date and time
end—date and time
all_day—if event is all day event
hidden_flag
day_of_week
day_of_month
month_of_year

Event to event similarity is an expensive computation and is computed offline in the way described in the following pseudocode:

function count_and_store_similarity(event, another_event) {

in_one_diary = number_of_events_in_one_diary(event, another_event)
return

in_one_diary/(number_of_diaries(event)*number_of_diaries(another_event)
}
function count_similarities(all_events) {

for event in all_events {

diary_entries = all_diary_entries_for_event(event)
similar_events = list( )
for entry in diary_entries {

similar_events.append(get_events_in_diary_with_entry(entry))

}
for another_event in all_events {

if another_event in similar_events {

count_and_store_similarity(event, another_event)

}

}

}

}

This is computed for all events added to the database compared with events already added into user diaries.

For all events, a huge matrix of event to event similarities is the result of this process. Storing only similarities of events with some minimal reasonable similarity makes this matrix smaller and faster to access. Thus, a matrix of events having a minimal reasonable similarity is stored.

Those offline computed similarities in the matrix can be later easily accessed to get event recommendations for a specific user based on the most similar events to those in the user diary for the specific user or the diaries of users to who he is connected in one or more of his social networks. In pseudocode:

function get_recommended_events (user) {

events_from_diary + get_events_from_diary(user)
recommended = get_most_similar_events (events_from_diary)
return recommended

}

There are two places where recommendations are used.

### Index Page and Category Pages

The first place is index page (shown in FIG. 2) and all category views where recommended events are always appearing at the beginning of each category. Those events are only based on collaborative filtering method with fixed limit of minimal similarity, so the accuracy of those recommendations is quite high.

### Event Details

At event detail pages (see for example FIG. 4A) “You may also like” consist of event from collaborative method (once again with fixed but lower than on category pages minimal similarity) at the beginning followed by events content-similar up to fixed number of events.

In one embodiment every event entry has an event address field. The crawler function 10 for managing the plurality of web crawlers automatically detects the event address (venue address) for each event. From the event address the function 10 for managing the plurality of web crawlers can detect a website address associated with the event and then generates a crawler to crawl for events from the associated website address. Thus the event database 14 is automatically populated with event data from the associated website address when the service was only initially provided with an event address (venue address).

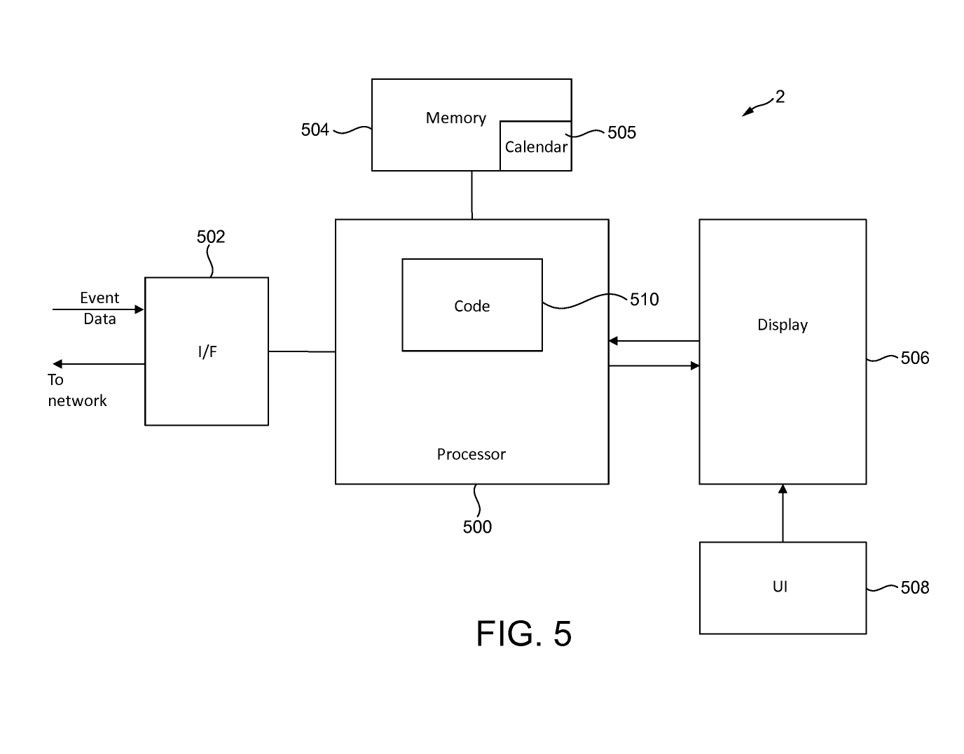

FIG. 5 is a schematic diagram of hardware at a terminal 2. Each user terminal 2 may comprise a processor 500 connected to a network interface 502, a memory 504 and a display 506. The display is associated with the user interface 508 which has an input device such as discussed before e.g a keyboard and/or mouse and cursor and/or touch screen. Processor 500 is arranged to execute code portions 510 which can be downloaded from the memory 504. The code portions implement the various event display functions described above by acting on instructions received from a user via UI 508 and returning relevant information presentation instructions to the display 506. In this way, the code portions in conjunction with the UI elements of the display constitute means for implementing various functions at the user terminal.

The memory 504 also provides a store which can provide a cache for the personal user diary.

When an event is selected, event data automatically updates the diary data. The diary data for each user is held at the server system.

The presentation information instructions which are supplied from the processor 500 to the display 506 include event data which is supplied from the event database 14 via the server system 8 through the network interface 502. It is assumed that event data incoming to the user terminal 2 via the network interface 502 has already been filtered to a significant extent such that management of the event information to be displayed can then be handled by the local processor 500 at the user terminal. It will be appreciated that the server system 8 and database 14 also include processors running code portions to implement various means which carry out their respective functions.

FIG. 6 shows the message flow in more detail. The server system 8 provides a handler function 600, a refine and filter function 602 and a diary function 604. A request transmitted from the user terminal is received by the handler function 600. As described above, the request includes the date, which is either the default date or the date selected by the user. In addition, the request includes a user identifier which identifies a user logged into the user terminal 2. The request can also include search parameters, etc. as described above. The handler function 600 supplies the request to the filter function 602 which accesses the database 14 to retrieve event data dependent on the date and the user identifier, and on any other search criteria which have been supplied with the request. Importantly, even if the user does not specifically enter any search criteria or other event-related information (such as categories), the filter function 602 nevertheless responds to the request by returning events which are refined for that user based on the user identifier. Event data for these set of events determined to be interesting to the user is returned in the event information message EIM to the user terminal 2.

When the user makes a selection of an event, a diary update message is transmitted from the user terminal 2 to the diary function 604 at the server system 8. The diary update message includes at least a user identifier and an event identifier. The user identifier allocates the update to the appropriate diary for that user. It will be appreciated that the diary function 604 runs a number of personal diaries associated with respective users. The event identifier in the diary update message allows the event data associated with that event to populate the diary for that user, as described earlier. The diary function 604 thus includes a store which holds data populating the diary. When the user uses an entry portal to enter a personal appointment, a similar diary update message is transmitted from the user terminal 2 to the diary function 604 to update the diary.

As mentioned above, personal user diary data can be also be cached locally in the memory 504 in addition to being held at the central server system 8 in the diary function 604.

As already explained above, the database 14 receives event data from crawler services 10, from API's associated with direct suppliers and possibly from a set of featured events which can be identified by the user of the server system or by other appointed users.

The database is updated with event data periodically or in real time. If event data for an event changes, the new event data is associated with the event identifier and automatically updates the diaries of users who had that event in their diary. This is carried out by the update function 606.

The update function 606 also allows a user to preselect a class of events (e.g. an open diary for a celebrity) which automatically updates their personal diary whenever a new event/appointment is added to the class of events.

In one embodiment, the user may customise the appearance of areas surrounding the user diary and calendar by subscribing to a themed “digital calendar skin” (hereinafter themed calendar). The media server 12 stores a range of media content associated with respective themed calendars. The user can browse and/or search the stored themed calendars and select to subscribe to one of them through a user preferences calendar settings window. The user terminal generates a calendar selection message including selection information (i.e. which themed calendar the user has selected to subscribe to) and a user identifier for that user, and transmits the calendar selection message to the diary function 604 where the user's calendar selection message is saved in a store of the diary function 604. The user may discontinue their subscription and/or subscribe to another themed calendar at any time by adjusting their settings. Once the user has subscribed to a themed calendar, whenever the user logs in to the calendar service, the appearance of a page area surrounding the user diary and calendar 20 is displayed according to the theme he has subscribed to. For example the user may subscribe to a themed calendar for the celebrity musician Taylor Swift. Any pages of the service displaying the user dairy and calendar will now have a Taylor Swift-themed appearance by including associated media in and/or around the user diary and/or calendar display. The media content associated with the themed calendar can include any one or more of static or animated text or images (e.g. photos, pictures, GIFs etc.), audio and audio-visual (i.e. video) elements. In the case of the latter two elements, the user can select to play the content directly from the screen of the user interface. The media content associated with the themed calendar can be updated periodically so that the user sees new content e.g. new content for every calendar month. Each time a subscribing user logs in, the diary function 604 recognises that the user has subscribed to a particular themed calendar and instructs the media server 12 to transmit the media content associated with that themed calendar to the user's terminal so that the media content associated with that themed calendar is displayed on the screen of the user-interface at the user terminal.

By subscribing to a themed calendar, a class of events associated with the themed calendar the user subscribed to will automatically populate the user diary without the user having to take any further action. The diary function 604 achieves this by generating and saving in the store of the diary function 604 an event class identifier for each available themed calendar. A respective event class identifier is saved against a subscribing user's calendar selection message. The update function 606 then uses the event class identifier to automatically populate the user diary (and calendar) with events based on event data that matches with the event class identifier. Taking the above example, the Taylor Swift-themed calendar will have a “Taylor Swift”-event class identifier which is saved against the subscribing user's calendar selection message. The update function 606 then uses any Taylor-Swift related event data in the database 14 to automatically populate the user diary with Taylor Swift related events.

As describe above, the event data in the database 14 may be updated by the addition of new events and/or changes to event data for existing event data already in the database 14. The update function 606 uses the event class identifier to detect any new event data that corresponds to the class of events associated with the themed calendar the user has subscribed to and automatically updates the user diary and calendar with new events. If event data for an event changes, the new event data is associated with the event identifier and the update function 606 automatically updates the user diary (as described above). Therefore the user diary and calendar are kept updated year on year with events relating to the themed calendar he has subscribed to, without the need for further user interaction. Therefore in the above example any new events, or changes to events, relating to Taylor Swift are updated in the user dairy so that the user diary and themed calendar are always up-to-date with events relating to Taylor Swift. The user diary and calendar are not limited to being automatically populated only with a class of events associated with the themed calendar the user has subscribed to; the user diary and calendar may also be automatically populated with one or more classes of events preselected by the user (e.g. an open (celebrity) diary, as described above).

The user interface can be arranged to enable a user to enter a search parameter and to receive the event data as a group of events sharing a common criteria defined by the search parameter. In that case, the user interface is configured to display the group as a stack wherein a single event image is visible with a user selectable icon for selecting the display of all the events in the group. FIG. 7A illustrates a user interface where the event display image on the right hand side is such a “stack”. This is the result of entering an artist name, for example, John Smith, into the text box 28 which allows entry of a keyword for a search. The event image has a user selectable icon 70 which, when selected, indicates a plurality of dates on which the artist is performing (see FIG. 7B).

Alternatively, by clicking on the image portion itself, a screen such as that of FIG. 7B is displayed, showing the image with other dates available.

This is a particularly efficient mechanism for providing event data to a user which avoids cluttering the user display. In FIGS. 7A and 7C, reference numeral 72 denotes a field in which the artist name can be displayed. In FIG. 7B, reference numeral 74 denotes a plurality of user-selectable add buttons, whereby each of the plurality of dates the artist is playing has its own add button 74. The user may choose to add one or more of the plurality of dates to his diary by selecting the corresponding add button 74 for the dates he is interested in. In one embodiment each of the one or more the add buttons 74 is displayed as a selectable check box whereby the add button 74 shows as unmarked or marked depending on the selections of the user. The user may select and then deselect any number of the one or more add buttons 74. When the user has finished making their selections they can select an “add selected events” button 76 so that the events on the dates as selected by the user are added to the user's diary at the same time. For instance, for a particular artist that is performing every night in the month of March 2012, the user will see the list of 31 dates in March 2012. The user may select two dates, for example 10 Mar. 2012 and 11 Mar. 2012. Once selected, the user selects the “add selected events” button 76 to add both of these dates to his diary. The user is warned by virtue of a popup notification should adding an event clash with another calendar entry.

In one embodiment, rather than events being displayed stacked by date, events are shown displayed stacked by venue address. As with the stack by date embodiment described above, the event display shows one image on the right hand side as a “stack”. This may be the result of the user a musical artist e.g. The Rolling Stones into the text box 28 which allows entry of a keyword for a search. The event image has a user selectable icon which, when selected, indicates a plurality of events for The Rolling Stones which are being held at various venues. Alternatively, by clicking on the image portion itself, a screen is displayed, showing the image with the plurality of events listed by venue (e.g. Royal Albert Hall, Wembley Arena, Glasgow Hydro and so on). The venues may be listed in alphabetical order, in date order of the next upcoming event, in order of proximity to a location set by user preference (e.g. a home or work location), or in order of proximity to the user's current position (as explained in more detail later).

In this embodiment, in FIG. 7B reference numeral 74 again denotes a plurality of user-selectable add buttons, but whereby each of the plurality of events being held at the respective venues has its own add button 74. The user may choose to add one or more of the events to his diary by selecting the corresponding add button 74 for the events he is interested in. In one embodiment each of the one or more the add buttons 74 is displayed as a selectable check box whereby the add button 74 shows as unmarked or marked depending on the selections of the user. The user may select and then deselect any number of the one or more add buttons 74. When the user has finished making his selections they can select the “add selected events” button 76 so that the events as selected by the user are added to the user's diary at the same time. The user is warned by virtue of a popup notification should adding an event clash with another calendar entry.

Whether the stacked groups of events are stacked by date or by venue, the events are preferably sorted by default based on the recommendation and ranking function 605 as described earlier. Thus stacked events are displayed ranked in alignment to the user's personalised settings and algorithms so that the most relevant events which the user is more likely to want to view are still shown above other events.

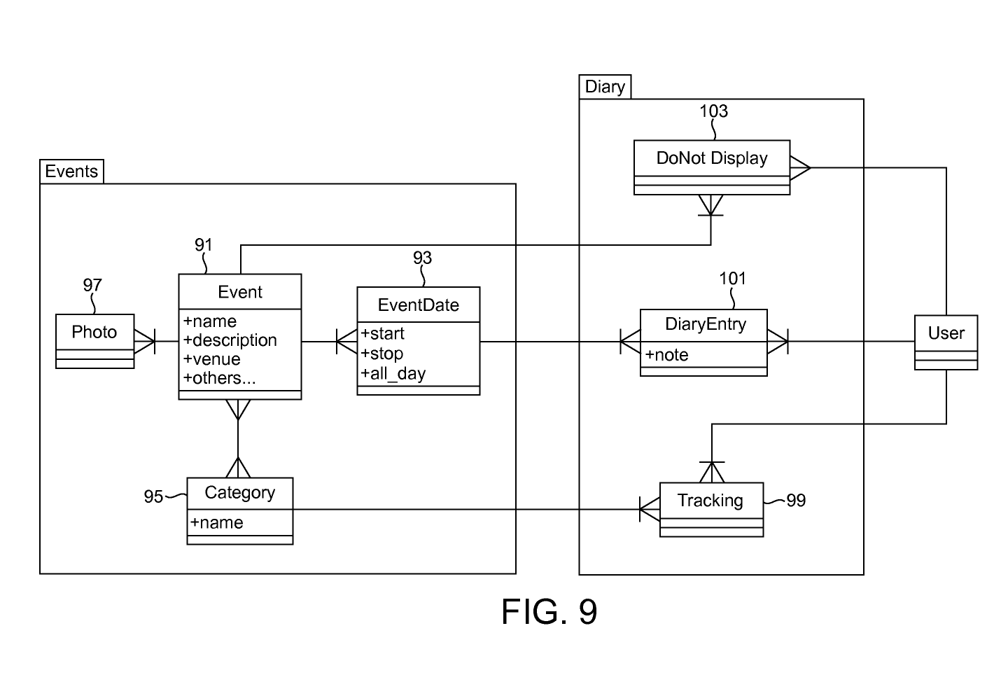

FIG. 9 is a schematic diagram illustrating the cooperation between a data structure 90 for the events data and a data structure 100 for the diary function 604. FIG. 9 illustrates as part of the generating of events (including events stored in the event database 14 and personal events of the user), an events data structure 90 comprising event data 91 (which includes the event entry fields “name”, “description”, “venue”, etc., as described earlier), event date data 93, category data 95 and image data 97 (e.g. a photo). The event data, event date data, category date and image data can each be implemented as a functional software component capable of interacting with each other and with data components that in part make up the data structure 100 for the diary function 604. For example, the data structure 100 for the diary function 604 includes a tracking data component 99, a diary entry data component 101, and a “do not display” data component 103 that are all capable of interfacing with a user. The tracking data component 99 enables the update function 606, as described earlier, to be implemented. The diary entry data component 101 allows an event to be added or automatically populated into a user's diary (e.g. if the tracking data component 99 has been implemented in parallel by the user). The “do not display” data component 103 allows a user to selectively hide events from being displayed in his diary or calendar. By accessing a preferences setting at any time, the user may cancel or undo a “do not display” action so that any hidden events are displayed in his diary or calendar once again.

In the present description, embodiments of the invention are described offering a number of improvements and advantages in the field of event data and diary/calendar population.

Embodiments provide a user device or devices all of which update if accessed under a single login, configured to automatically aggregate event information (an event being something a person may attend or observe or take-part in) and populate a user diary or be present within the diary/calendar database allowing the user to add a single or multiple events into the calendar, the device comprising:
a processor configured to execute a program which generates a request identifying a date and/or dates, and/or location and or keyword such as artist or venue or interest or category;
means for transmitting the request to an event database;
means for receiving from the event database event data corresponding to the selected date and/or dates, and/or location and or keyword such as artist or venue or interest or category;
a user interface configured to present to a user event information based on the event data and/or dates, and/or location and or keyword such as artist or venue or interest or category for the selected date or dates so as to permit a user to select at least one event for populating the user diary and or adding it to their social network sites, and or sharing the event with their contacts, whereby selection of the event by the user automatically imports the event to the diary/calendar, by updating stored diary data.

By virtue of populating the diary the user now also gets a map showing the event location, travel updates to the zip/postcode area, weather updates if within forecasting range of the area selected, and the ability to find nearby restaurants and/or bars and/or other places of interest. All such data can be shared. The user can also select the map and choose to look anywhere in the world for similar or any event. The user can select and save keywords to preferences allowing the database to push notify the user of similar events being posted into the database. The user can select to ignore or add the event directly into the calendar. The user is warned by virtue of a push-notification popup should adding an event clash with another calendar entry.

A clash warning message popup may be based on the location of an event that the user attempts to add to his diary in respect of the location of an existing event already added to the user's diary. In one example the user already has a diary/calendar entry for an upcoming event dated 10 Mar. 2012 at 12:00 pm with a location of London, United Kingdom. Another upcoming event is subsequently added to the user's diary with a date of 11 Mar. 2012 at 12:00 pm with a location of Sydney, Australia. Although the events do not clash by time, a clash notification means of the service can detect that the time window for the user to travel from the London event to get to the Sydney event in time is unlikely to be long enough. The clash warning pop up will alert the user that it may be difficult to get to the second event on time. The user can disregard the clash warning and the event is still added to the user's diary.

To select a date, the user taps any date to view events on that date. For a date range the user taps a date, holds down and scrolls to the end date before releasing their mouse button.

Each ‘signed in’ user is presented with a bespoke set of events based on algorithms which track the users navigation and other users tracked navigation whereby the same event has been viewed and the probability of navigating forward is anticipated based on where the majority of other users go. This means the user is always looking at relevant events that they are likely to like or want to know about. This unique event display, made for each individual user, can be refined further by virtue of personal preferences (nearest within a defined perimeter . . . furthest from current location or any input zip/postcode . . . free . . . most to least expensive and vice versa . . . date soonest to furthest and vice versa . . . scale of event . . . time of day, soonest to furthest and vice versa . . . alphabetical a-z or z-a . . . by venue . . . ticketed . . . by artist . . . most popular . . . random.

Categories also comprises sub categorisation. The categorisation works in tandem with keywords with the event detail so as to automatically rank listings so as to be most relevant to the user. The user themselves can determine or input keywords, which help rank an event higher for them, but also the calendar algorithm determines ranking a category higher based on keywords which may repeatedly appear in detail about the event during the users navigation history. The unique structure of code is able to stack similar events into a single event window so that the user is not deluged with a repeat artist playing multiple dates for example. The stacking displays one artist with text to indicate that multiple dates are selectable. The user interface further allows the user to see all dates by selecting a single ‘+’ button within the event box. This is presented in a modal window.

Algorithms will also present similar events in multiple categories within a ‘you may also like’ section beneath the main category on display.

The calendar recognises the user's location and can push/display events to their device for that location. The user is able to switch to any one of multiple post/zip codes at any time through the filter, and layer results. For example, if a user is in location A and selects to view events in that location, then selects one event, the system will indicate if that event is also in other locations, whereby the user can display those events. Or a user can input any other location and select ‘similar events’ to find matching events in other locations. When the user performs a swipe-down action on the user interface while viewing any page of the service, the address of the user's current position is displayed to the user. When a user has not searched for an event or location, the service is configured so that the event map 39 is automatically populated with the address of the user's current position. Thus by default the user will see events shown marked on the event map 39 relative to his current position. The events that are shown may be in alignment with the user's personalised settings and algorithms so that the most relevant events which the user is more likely to want to view are shown above (or before) other events.

Geo-location can be selected in user preferences allowing the user to, by default, view nearest events. For example the user may select to view the nearest 30, 50 or any other pre-defined number of events, based on their current location. Alternatively or in addition, the user may select to view events that are within a defined radius of their current location. For instance the user may select to view events that are located within a radius of 1 mile, 3 miles, 5 miles or any other pre-defined distance, from the user's current location. In both scenarios the events are preferably sorted by default based on the recommendation and ranking function 605 as described earlier. Thus events that are nearest in location to a user are displayed, but ranked in alignment to the user's personalised settings and algorithms so that the most relevant events which the user is more likely to want to view are shown above other events.

A selectable icon on the user interface allows the user to (i) view a world map (ii) drag and select any country, town, or place, always being presented with ‘popular’ event markers on the map, wherever they look. The user may also input single or multiple zip/postcodes and view events by filter, in all locations simultaneously. Entry of a post/zipcode automatically creates a map within the calendar, so that the user can view their event and see its location in respect of their location.

The location device which automatically determines the position of a user and generates the location indicator works in alignment to the user's personalised settings and algorithms to display relevant events which the user is more likely to want to view. In addition the user can enter other addresses within the maps and get directions from A to B. Traffic updates according to the route are automatically fed into the user's diary; if the user selects travel by public transport then the diary/calendar is automatically updated with any such delays. A displayed event can show how far away an event location is from a current determined position of a user. This applies to both searched events and events in the user's diary. For example if a user enters a search for the artist “Paul Weller”, the displayed events can show how far away any “Paul Weller” related events are from the user's current position. The user may sort the event results so that they can view events of interest by how far away the events are from the user's real-time current position. Similarly, a user can view events in their calendar or diary and see how far away the event locations are in respect of their current position. The events may also be sorted based on the recommendation and ranking function 605 as described earlier. Thus events are displayed ranked in alignment to the user's personalised settings and algorithms so that the most relevant events which the user is more likely to want to view are shown above other events.

A push-notification warning or reminder message can be delivered to the user based on the service determining the user's current position with respect to the location of an upcoming event and how soon before that event is due to start. For example, the location device detects that the user's current position is London, United Kingdom. The user already has an event in his calendar that is due to start in two days' time in Sydney Australia. The clash notification means of the service calculates that a warning/reminder based on the time to get to the event location from his current position should be sent to the user by push-notification. The user is thus reminded about any events he may have forgotten about. The warnings/reminders are dynamic such that in another example if the user's current position is North London and he has an event in his calendar located in South London for later that day, a warning/reminder can be generated and pushed to the user 2 hours before the event is due to start. This should still give the user ample time to get from his current location across the city. The user can adjust user preferences to set how early he receives a warning/reminder based on his current position with respect to the location of an upcoming event in his calendar, or to disable all warnings/reminders being pushed to him at all.

As an alternative to an activatable icon for selecting the event, the entire event footfall can be used for selecting the event. Also the event can be added directly to the calendar from the image portion.

The user interface is configured to display to a user means for selecting different diary views, the different diary views including day mode, week mode and month mode, derived from the stored diary data. Each view can be preferenced by a user, meaning they can select which day of the week their week-view starts . . . the hours displayed in day-view . . . whether month view is the next 31 days or the current month. The user enters their event and/or meeting into predetermined fields of the modal window allowing their event to display in the same way as a commercial event. Personal events can be marked in the diary views with a personal event icon and database events with a database event icon. In the calendar view, any date on the calendar on which a selected event takes place includes a marker, wherein the marker for personal events differs from that for database events. The user can set preferences to select different colour markers for different genres such as ‘home’ ‘work’ ‘family’. When the user hovers over the marker a modal window appears showing the event detail.

The user interface is operable to present to a user a modal entry window for entering details of a personal event for populating the diary. The user can upload an image and/or video to accompany their entry. They can opt to list their entry on their other social network sites. The database will present other events to the user based on keywords that may appear in the users data, such as same location events nearby; events that have the same meaning. For example if the user inputs a diary event such as ‘drum lesson’ and then the address, the database will return listing for drum shops in that area . . . or perhaps a famous drummer is doing a book signing in the area . . . or there's a drum seminar. User input data relates directly to the events database and works in tandem to present relevant information to the user.

Event data is returned based on user personalisation and algorithm-detected preferences, resulting in relevant discovery and listing. The database and algorithms serve to display data ranked in what it believes the user wishes to see. Resulting information also determines the exact advert to be shown alongside any event as well as relevant discount vouchers, which relate either to the event and/or a similar category of product. For example, if the user is returned with an event ‘Disney On Ice’ at Wembley Arena; then it is likely they will see an advert for EuroDisney as well as a discount voucher for the Disney Store or to the cinema to see a new Disney film. All data can be added to the user's diary with clicking ‘+’.

The user can select to view or hide any number of categories or sub categories. Furthermore they can ‘drag’ each category window into the order they wish to view them from top of page to bottom. The selection of category forms part of the basis of future events displayed to the user. For example, if the user selects the category of premiership football and selects to add the entire premiership schedule into the calendar/diary, then the database remembers this selection and will constantly update the data entries in the calendar, push notify of any changes, and auto update the calendar year on year without further user interaction, thereby negating the need to select categories in the future.

Geo-location can be selected in user preferences allowing the user to, by default, view nearest events.

The database stores a type of events with a preference tag, the preference tag ensuring the return of the event responsive to a request if it meets the category and date criteria in the request, but regardless of other search parameters. The user may select any tag in order to view other related events.

The user can opt to display ‘events they've clicked on previously’ as a permanent feature thereby negating the need for a user to act proactively to see such data.

Search is predictive and is recognised as vertical search, search solely from the database. The search field recognises the characters instantly to when the user starts typing and immediately predicts potential events to negate the user having to type extensively. For example if the user types “GE . . . ” a modal window will open to display all “GE” events in the database starting with what the algorithm tells it is most likely to be what the user is looking for. In other words the user will see “GEORGE MICHAEL IN LONDON” “GEORGE HARRISON ANTHOLOGY RELEASE DATE” etc. When the user sees an exact match he may select that to see solely one event. This is ultimate refinement. User may prefer a more open search for “George” with the result being all ‘george’ events.

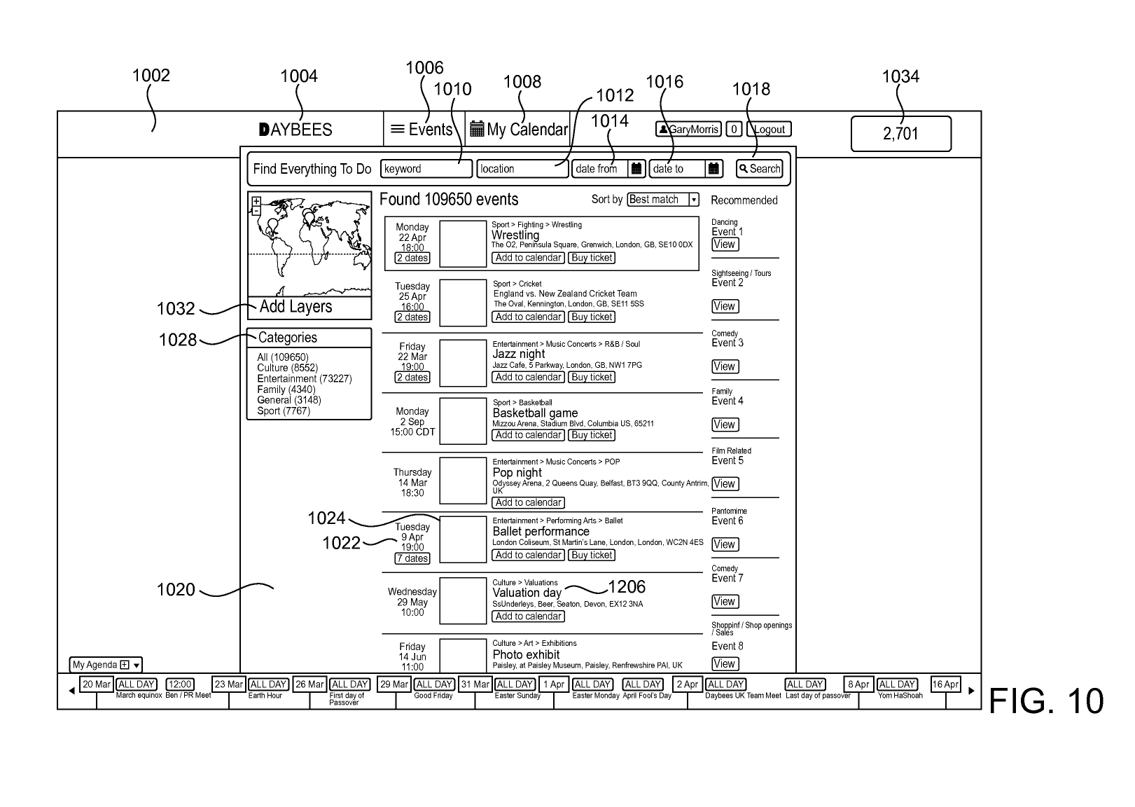

When an event is automatically updated the user will receive a push notification. All of the user's devices and systems will update under the same login. Whereby an event is updated and that update causes a clash with another diary entry the user will need to accept (in the push notification) which event should take preference. As shown in FIG. 10, push notifications may be displayed in a push notifications icon 1034 located in the home bar 1002. The push notifications icon 1034 may be located at any other location of the displayed pages of the service. The push notifications icon 1034 displays the number of new notifications to be viewed by the user. In the example shown in FIG. 10, the user has 2,701 pending notifications to view. The push notifications icon is user-selectable such that when a user selects the push notifications icon, a list of the push notifications is displayed to the user in a modal window regardless of what page of the service the user is currently viewing. In this way a user can easily access and view all of the push notifications he has received without having to access or navigate to his populated diary or calendar.

An application programming interface (API), comprises program code arranged to receive information defining an event from an event source and to transform the event information into event data in a format suitable for loading into an event database. Other website developers will be able to use this API to easily adapt their websites to work with the database. For example a school would integrate the API in their website design so that when they enter their term schedule, their site displays the data for one-click entry into the diary.

The remaining embodiments and variations describe further advantageous ways a service user's calendar/diary may be populated automatically with events. The remaining embodiments also provide a way for displaying the user's events in an efficient way so as to allow the user to view his events in a user-friendly way that requires less navigational input on the part of the user.

Variations on how the user interface displays events and the diary/calendar are described with relation to FIGS. 10, 12, 12b, 12c, 13, 14a and 14b. It is to be understood that the user device still operates in essentially the same manner as descried in the above embodiments. The pages of the service are merely navigable in an alternative way and the user interface displays the events and diary/calendar in a different way. In addition, a simpler technique for uploading specific categories of data such as public holidays is described.

FIG. 10 shows an event view page of the service. All pages of the service, including the event view page comprise a home bar 1002 that is displayed across the top of the display. The home bar 1002 comprises a home button 1004 that when clicked causes the user device to navigate to the home page 300 of the service (as described in more detail in relation to FIG. 2), an Events mode button 1006, and a My Calendar button 1008.

The user can select and click the Events mode button 1006 from the home bar 1002 to cause the user device to be navigated to the event view page of the service that is displayed by the screen of the user device. At the event view page the user is able to search events stored in database 14 by entering one or more of the following pieces of information into one or more of the respective search fields: one or more keyword(s) into field 1010, a location into field 1012, a date rage into fields 1014 and 1016, and then clicking the search button 1018. Similarly to previously described embodiments event results are displayed in a main event view area 1020 in a listing format and for each event a date and time of the event 1022, an image representing the event 1024 and a brief textual summary of the event 1026 is displayed.

In the event view page there is an alternative or additional option to entering search times into the search fields: a user may manually browse all events or search result events by clicking through browsing categories links 1028. Clicking on a category link refines the displayed events to events of that category only. The category links 1028 may comprise cascading sets of sub-categories 1030 for any category so that the category can be expanded/collapsed by the user allowing them to then click on a sub-category to further refine the event results that are displayed when they are browsing. Sub-categories themselves may have further sub-categories and so on. A user may select more than one category 1028 or sub-category 1030 so that events associated with two or more separate categories (or sub-categories) can be displayed in the main event view area 1020.

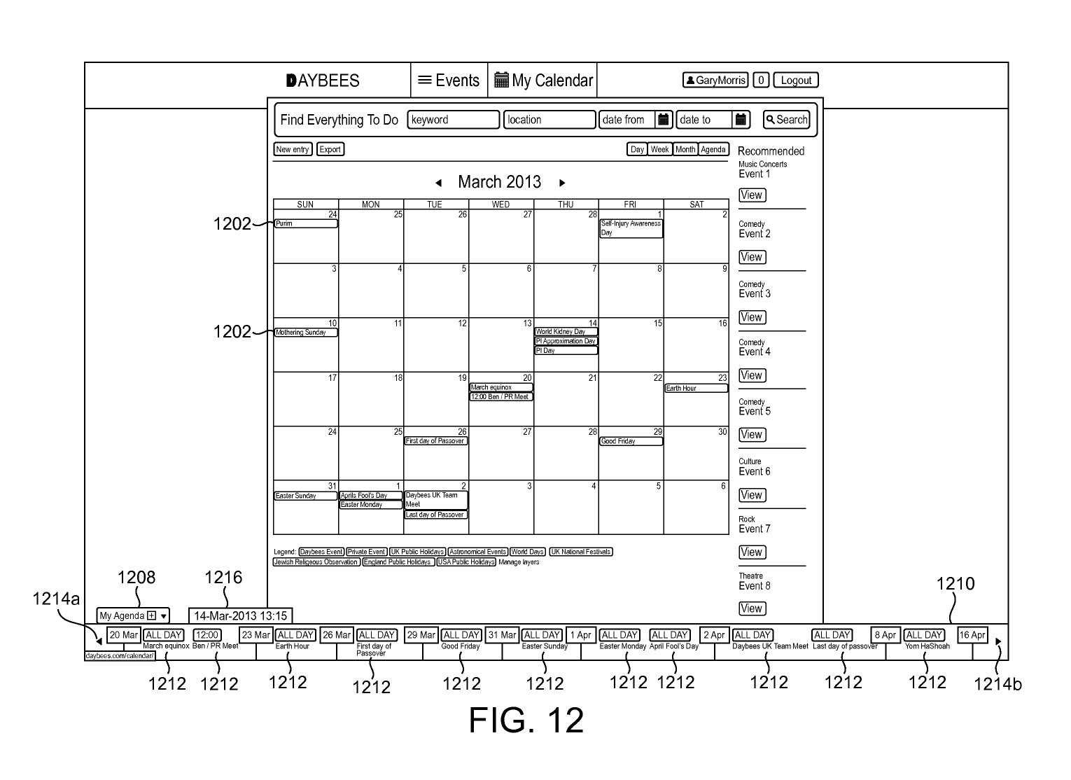

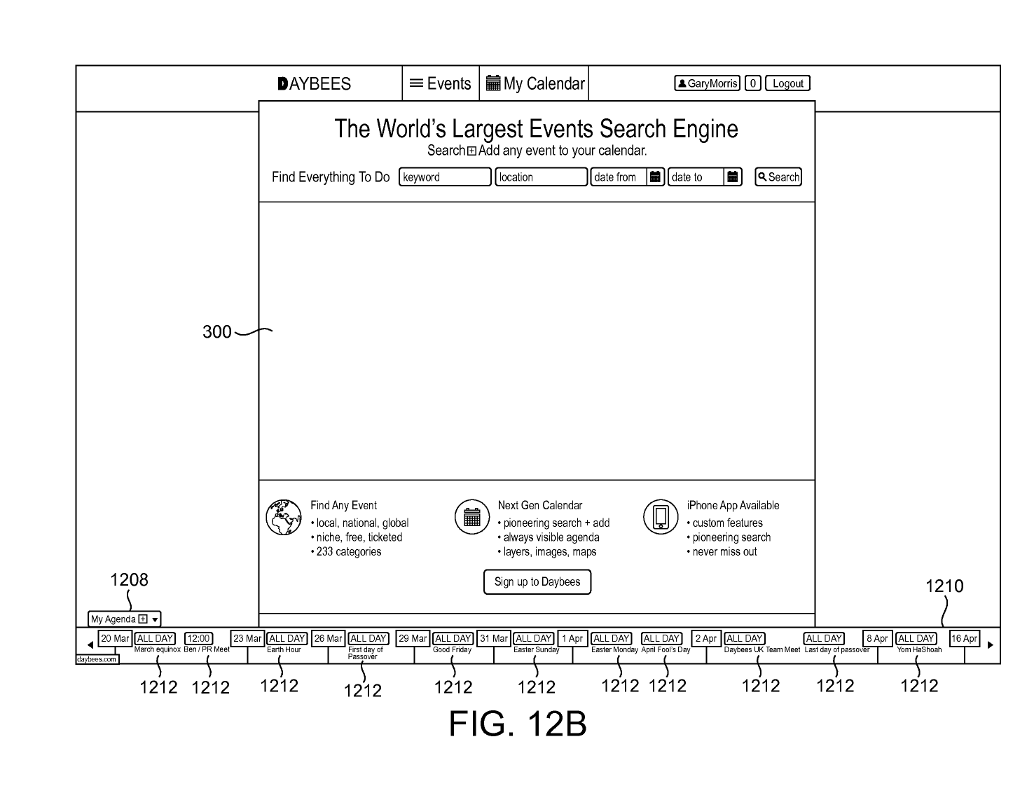

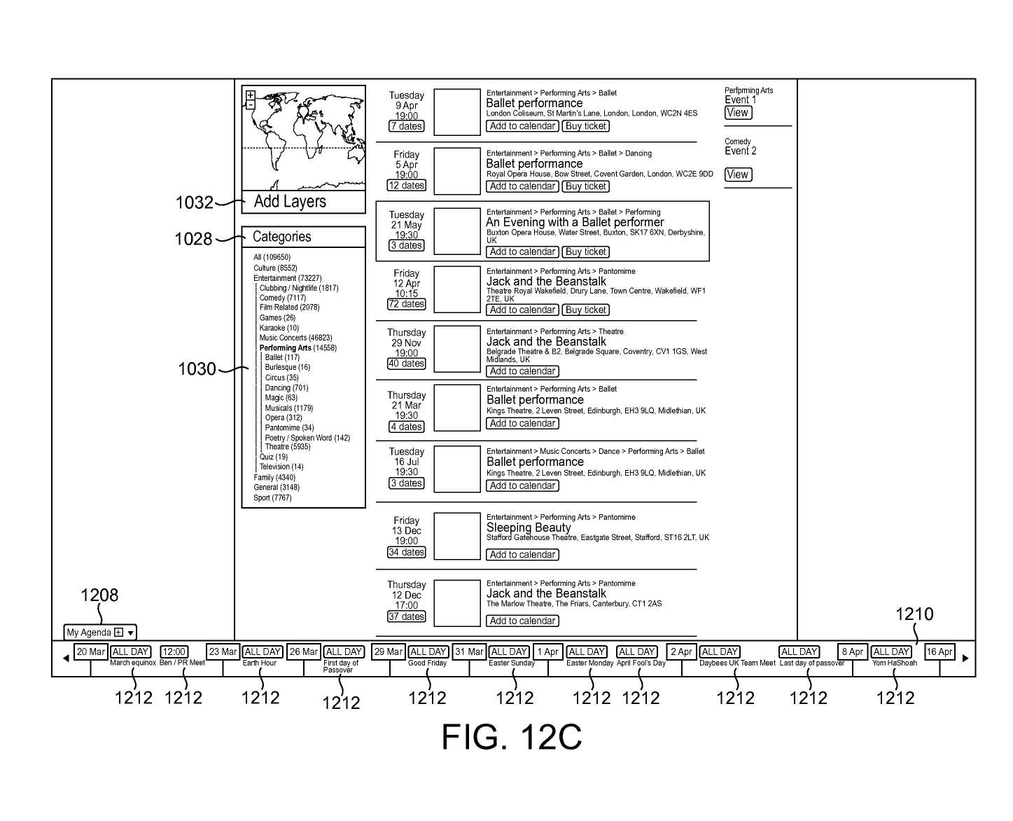

The user may select the My Calendar mode button 1008 from the home bar 1002 to cause the user device to be navigated to the calendar view of the user's diary/calendar as was described previously. When the user selects the My Calendar button 1008, the calendar view is displayed in month format by default as shown in FIG. 12. Here the user can view events marked in his calendar as described previously and later on in relation to FIG. 12.

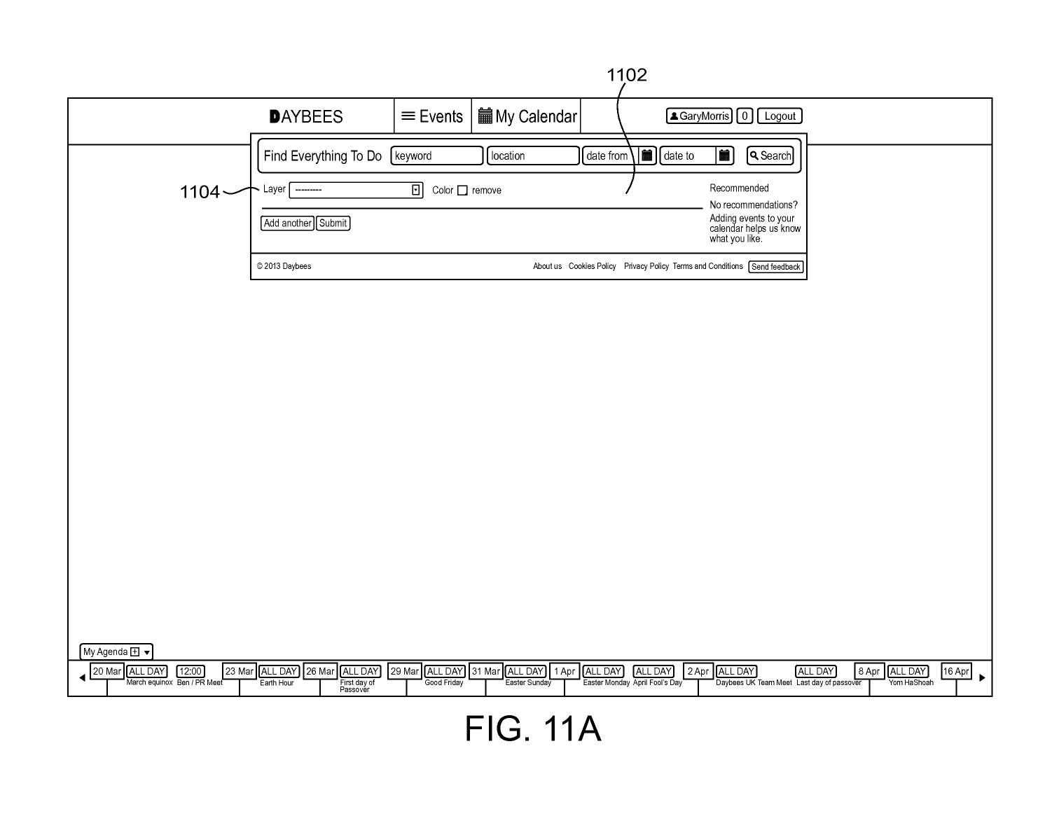

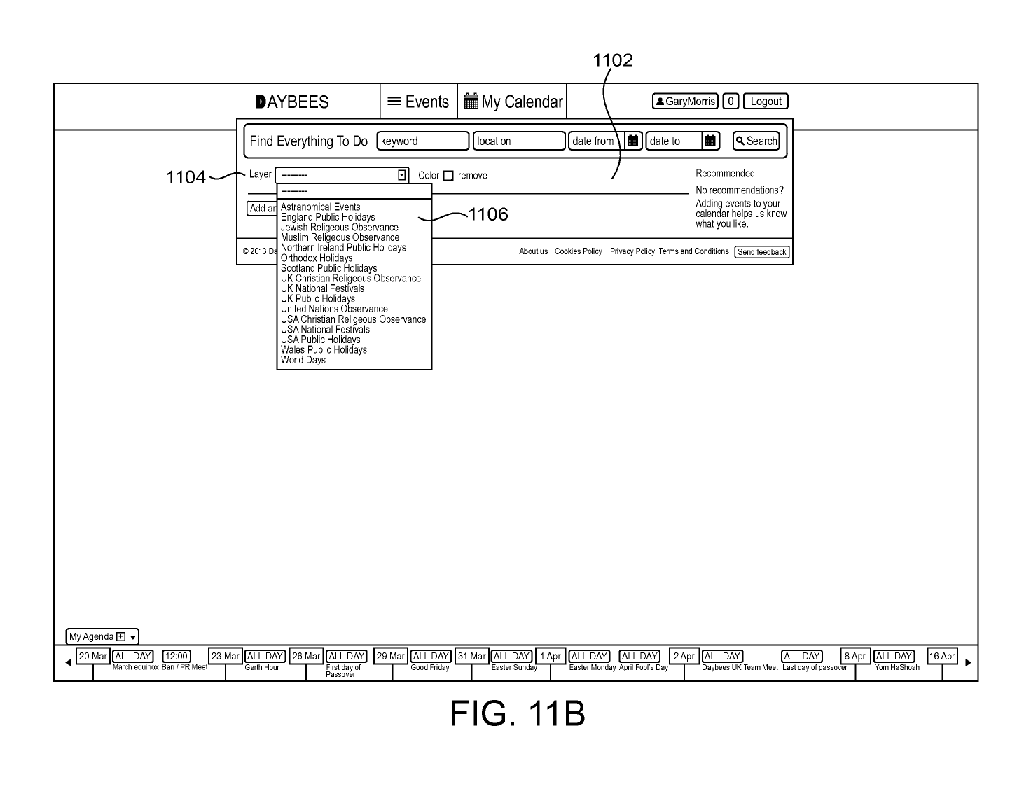

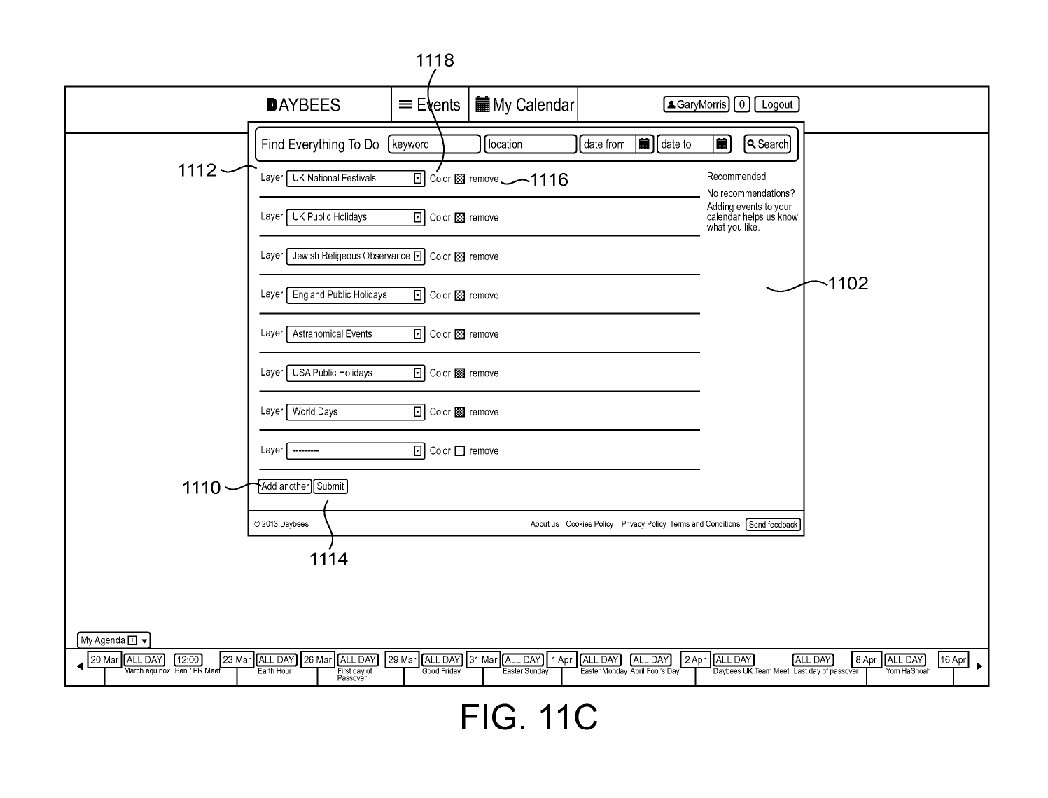

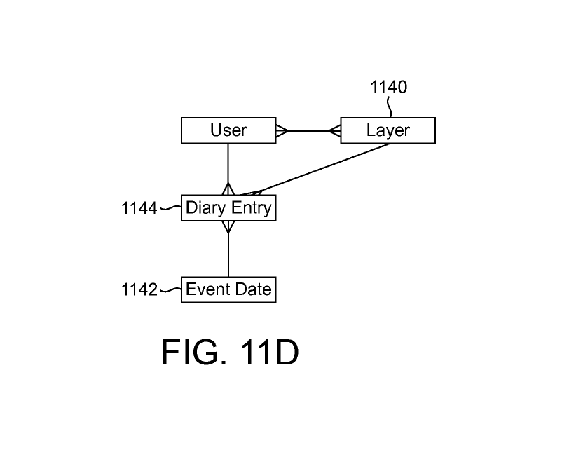

With reference to FIGS. 11a to 11c, in another embodiment, one or more events can be automatically added to a user's diary/calendar by the user selecting to add one or more “Layers” at a Calendar Settings window 1102 of the service. One way the user can access the Calendar Settings window 1102 is via a user profile preferences window of the service.

A Layer is not a searchable event and can only be added, managed or removed from the Calendar Setting window 1102 as described in more detail below. Typically, a Layer is associated with a number of future events that may fall on the same or different days, and that are likely to be of interest to a number of users of the service e.g. one Layer could be UK Public Holidays, another Layer could be USA Public Holidays, and another could be Astronomical events and so on. The individual events associated with a Layer are stored in the database 14. Similarly to earlier described embodiments, Layer Events associated with a particular location may be stored on a particular database; for instance UK related Layer Events stored on UK database 14a, USA related Layer Events stored on USA database 14b, Europe related Layer Events stored on database 14c and so on. Again it will be appreciated there be any number of servers each storing events and Layer Events, either global or associated with a particular location.

When a user selects a Layer, the processor 500 at the user device formulates a request including a Layer identifier which is transmitted to the event database 14. A response is returned including the including the group of events associated with that Layer identifier. At the database 14, Layer Events are stored with the Layer identifier in addition to the other event data discussed earlier.

With reference to FIG. 11a, a user adds a Layer to their Calendar at the Calendar Settings window 1102 in the following way. The first time the user accesses the Calendar Settings window 1102, they will be presented with an empty drop down menu 1104. With reference to FIG. 11b, the user can click the drop down menu 1104 to see a scrollable list of many different Layers he may choose from. The user selects one Layer from the drop down menu by clicking on the item that interests him e.g. in this case UK Public Holidays 1106. Now referring to FIG. 11c, the user may then add a second Layer by clicking the “Add another layer” control button 1110. A second drop down menu 1112 that offers the same list of Layers is generated below the first drop down menu 1104. The user can then select another Layer. The user may repeat this process many times so that each time he selects the “Add another Layer” control button 1110 a new drop down menu is generated below the last one. This way a user may add many different layers in the Calendar Settings window 1102. The Layers that can be selected are named and maintained by an administration service (Admin). Only the Admin can create new Layers that may become available for the user to add to his Calendar.

When the user has finished selecting the one or more Layers he clicks the ‘submit’ control button 1114. His Calendar Settings preferences are transmitted over the network and stored at the database 14. The user's diary/calendar will then be automatically populated at the user device with the events associated with the Layers he selected whenever he accesses the service. Because the user's Calendar Settings are stored by the database 14, whenever the user subsequently accesses the service, the Calendar Settings window 1102 will always display his most recent preferences and Layer selection(s).

FIG. 11d is a schematic diagram illustrating the interaction between the user, the Layer(s) 1140 that he adds, the Layer events associated with the selected Layers (“Event Date” 1142) and the diary function 604 (labelled in FIG. 11d as “Diary Entry” 1144), which populates the user diary with the Layer events associated with the selected Layers.

The Layer events displayed in the user's calendar are not editable and cannot be removed from the diary/calendar directly. A Layer is only manageable at the Calendar Settings window 1102 of the service. Another way the user may access the Calendar Settings window 1102 is by clicking an “Add Layers” control button 1032 displayed above the categories links 1028 in the event view page (as depicted in FIG. 10). Clicking the “Add Layers” control button 1032 causes the user device to be navigated directly to the Calendar Settings window 1102 where the user can manage his Layers.

The user can manage his Layers at any time at the Calendar Settings window 1102. Here the use may add or change one or more new Layers by following the steps as outlined above.

The user may also remove any one or more Layers he previously added by selecting the ‘remove’ button control 1116 next to the Layer drop down menu for the Layer he wished to remove. When a Layer is removed, all events associated with that Layer are immediately removed from the user's calendar/diary so that these events will no longer be displayed in any way across the service for that user.

The user can also manage any Layer added to his calendar by assigning a colour to each layer by selecting colour control button 1118 next to each Layer drop down menu in the Calendar Settings window 1102. Colour control button 1118 causes a sub-window to appear from which the user can select a colour from a pre-defined range of colours. Each Layer Event associated with a particular added Layer will then be populated in the user's calendar/diary view highlighted in the selected colour for that Layer; e.g. the user may assign the colour blue for UK Public Holidays; any UK Public Holidays will be populated in the user's diary/calendar highlighted blue.

FIG. 12 shows an example of calendar view displaying the month of March 2013. The calendar is populated with a number of events 1202, which may include private events generated by the user or shared by a contact, searched events from the database 14, and Layer Events. The calendar includes a legend 1204 comprising entries for each of the user's added Layers displayed in the calendar view, and for each of their private and searched events. The legend 1204 further comprises a “Manage Layers” control button 1206 the user may select to cause the device to navigated directly to the Calendar Settings window 1102 of the service, so that the user can manage their Layer settings as described above.

In all of the described embodiments of the invention, there is a user-actuatable tab element 1208 that is always displayed within a fixed position on the screen of the user device when he visits any page of the service using his web browser e.g. the home page 300, diary views, calendar views, event view, or indeed any page of the service. The tab element 1208 is a tab labelled “My Agenda” as illustrated in FIG. 12, which shows the tab displayed in the bottom left hand corner of the calendar view, as displayed at the user's device. The skilled user will appreciate that the fixed position of the My Agenda tab 1208 could be located elsewhere on the screen.

Displayed below the My Agenda tab 1208 is the Agenda Bar 1210. The Agenda Bar 1210 runs horizontally along the width of the displayed service page. Like the My Agenda tab 1208, the Agenda Bar 1210 is visible across any page of the service. By default the Agenda Bar 1210 is always displayed, however, a user has the option to hide/close it as discussed later. The position of the Agenda bar when displayed or hidden is stored as a cookie in a memory 504 of the user device so that the Agenda Bar 1210 can always be easily displayed at the user's screen whenever the service is being accessed. This way the Agenda Bar 1210 does not have to be downloaded from the database 14 for each page of the service the user visits.

When the Agenda Bar 1210 is displayed, it is populated with the user's upcoming one or more events 1212 in chronological order. The displayed one or events correspond to the one or more events the user has added to their diary, including any Layer Events that are automatically populated based on Layer(s) the user may have added to his calendar. At the far ends of the Agenda Bar 1210 are arrow control buttons 1214a and 1214b that enable the user to horizontally scroll through events and Layer Events in the Agenda Bar 1210 if there are more events populated than can fit in the in the Agenda Bar 1210.

The My Agenda tab 1208 also displays ‘today's date’ (for example 14 Mar. 2013) 1216 and current time. The today's date information 1216 is a user-actuatable control in that the user may click on the date and the device will navigate to the event view and display at the user's device, events for the day. The user may then search/browse through events in the event view as described above. FIG. 12b shows an example of the home page 300 with the Agenda Bar 1210 displayed with the user's populated events 1212. FIG. 12c shows an example of the event view being browsed with the Agenda Bar 1210 displayed with the user's populated events 1212.

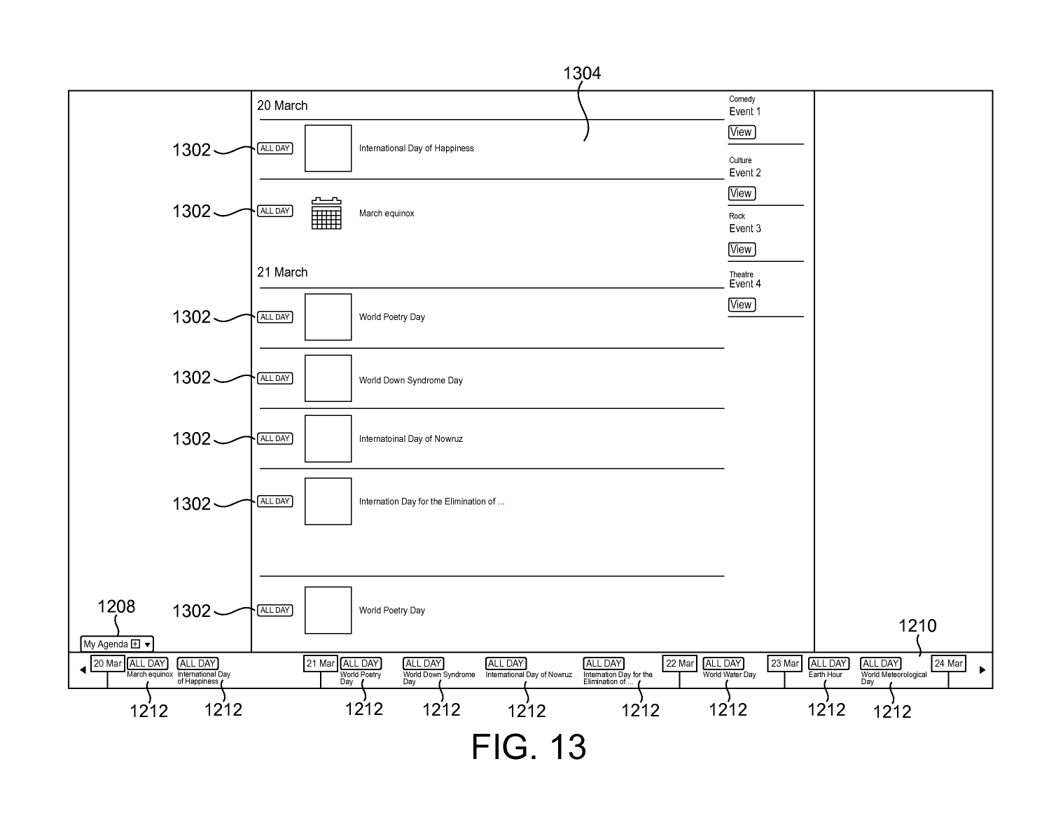

Alternatively, as depicted by FIG. 13, if the user clicks on the ‘today's date’ control 1216 while already viewing his events in calendar view, the service will navigate the calendar view page to display the user's events and any Layer Events for the day in calendar view (day format). In this way, the same events 1212 as displayed in the Agenda Bar 1210 are shown more fully 1302 in a main display area 1304 in the calendar view. If there are more events than can fit in the main display area 1304 of the calendar view, the main display area 1304 is scrollable vertically so that the user can see all of the day's events. The main display area 1304 of the calendar view is also continuous. That is, if the user has no events populated for today, the main display area shows events for the following day(s). The user can keep scrolling down the main display area 1304 to show his populated future events and Layer Events for every day, far into the future.

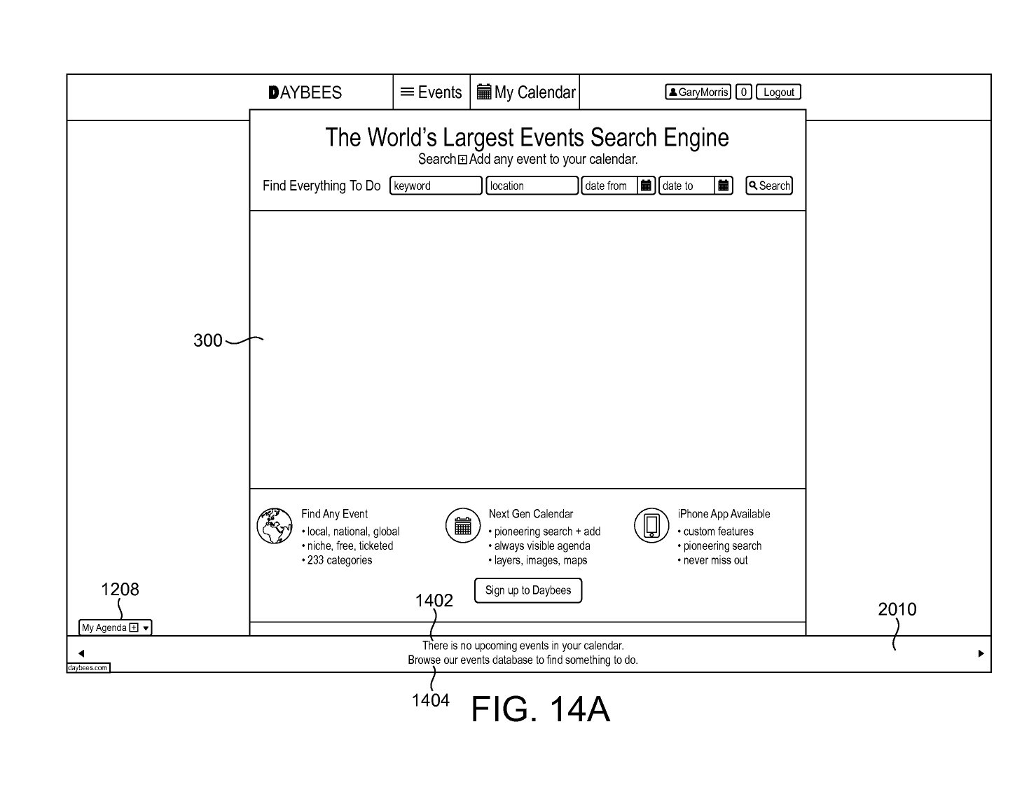

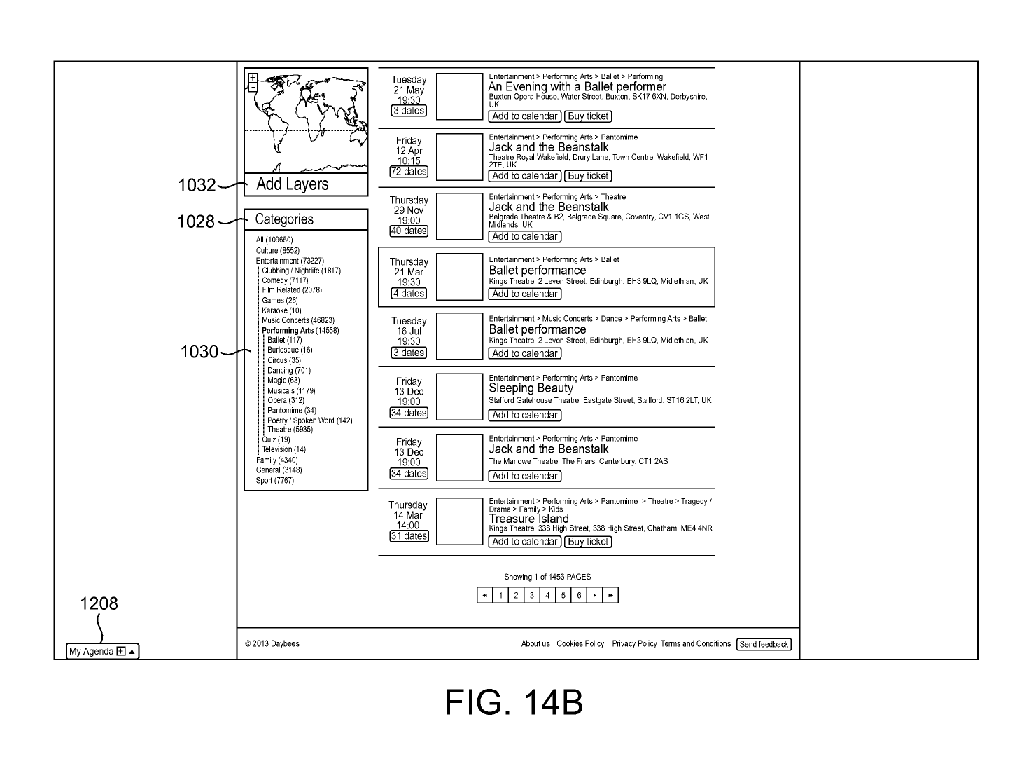

FIG. 14a shows an example of the home page with the Agenda Bar 1210 displayed. If the user has not added any upcoming events to their diary, or not added any Layers, the Agenda Bar 1210 displays no events and instead displays a message 1402 to show that there are no events in the user's calendar. A clickable link 1404 is also displayed beside message 1402 that will cause the user's device to be navigated to the event view page so that the user can search/browse events in the event database 14 as described previously.

FIG. 14b shows an example of when the Agenda Bar 1210 is hidden/closed. By default, the Agenda Bar 1210 is always visible on every page of the service. However the device user may click on the actuatable My Agenda tab 1208 to hide/close the Agenda Bar 1210. The user may then click the My Agenda tab 1208 again to expand the Agenda Bar 1210 and make it reappear at any time. As an example, FIG. 14b shows the event view page as normal while the My Agenda tab 1208 remains visible in the bottom left hand corner but the Agenda Bar 1208 has been hidden/closed and is not visible.

Other functionality includes
INSTANT CHAT.
   A user sees an event they like they can click on a chat button . . . select the friend they'd like to chat with . . . and discuss the event with them, whereby they can both then add the event into diary.
MICRO SITES.
   Similar to the author pages for open access. In this instance companies have all their events in one address. For example “Daybees.com/Disney” to find all Disney events, with everything one-clickable into diary.

Events associated with a user's (or company's) microsite appear with the suffix “PRO” after the event name. The Event is also highlighted by being displayed in a different colour to any other non-“PRO” events shown displayed in the event search page.

As described above, search is predictive when the user starts typing in the search field. In one embodiment, in addition to the predictive potential events, there are up to three other types of predictive results that can also be shown in the modal window. The predicted potential events and results are displayed under up-to four separate headings being:

### i) Venues

ii) Categories (of events)
iii) Events

### iv) Microsites

As an example a user may start typing into the search field the letters “Roy . . . ”. The predictive results in the modal window could include the following results (amongst others) under the respective headings: i) Royal Albert Hall (venue); ii) Royalty (category of events); iii) Royal Ascot (event); and iv) The UK Royal Family (microsite belonging to the UK Royal Family).

If a user selects a potential result listed under the “Microsites” heading then the user is taken to the microsite for that user or company i.e. in the above example the user would be taken to the microsite for the UK Royal Family (the microsite would also be directly accessible for instance at www.Daybees.com/UKRoyalFamily).

What is claimed is:

1-11. (canceled)

12. The user device of claim 43, wherein the screen of the user interface displays a user selectable “buy tickets” button when the user performs a side-swipe action on information for one event presented on the user-interface.

13. (canceled)

14. The user device of claim 12, wherein when the user selects the “buy tickets” button, the screen of the user interface displays at least one of:
contact details for ticket sellers;
a ticket sales webpage; and
an affiliate ticket seller's website.

15-17. (canceled)

18. The user device of claim 43, wherein when the stacked group of events is selected to display all of the events in the group, the events are ordered based on the venue address of the event.

19-29. (canceled)

30. A computer system for managing event data comprising:
a database storing event data relating to a plurality of events, each event associated with an event date;
a handling function for receiving a request from a user terminal, the request including at least a user identifier, a date and a search refinement criteria;
a filter function for returning event information corresponding to the date in the request;
wherein the handler function is operable to supply the request to the filter function for accessing the database, the filter function is operable to return events based on the user identifier and any search parameters supplied in the request, and to return events based on the user identifier where no search parameters are supplied in the request; and
a crawler function for managing a plurality of web crawlers for automatically detecting a venue address for an event, determining a website address associated with the event based on said venue address, generating a crawler to crawl for events from the associated website address, and populating the database with event data relating to a plurality of events crawled from the associated website address.

31. The computer system of claim 30, comprising a push notification function arranged to transmit a push notification message to the user terminal identifying events in a user diary and/or events of possible interest to a user at the user terminal.

32. The computer system of claim 31, comprising a clash notification, function, the clash notification function being arranged to issue a warning message to the user on an attempt to update a diary with an event which clashes with an existing event in the diary.

33. (canceled)

34. The computer system of claim 32, wherein the warning is issued based on the location for the event attempting to update the diary in respect of the location of the existing event in the diary, wherein the clash event notification function determines that there will not be time for the user to get from the location of the existing event in the diary to the location for the event attempting to update the dairy.

35. The computer system of claim 32, wherein the clash notification function is arranged to issue a reminder to the user based on the user's current position in respect of the location of an upcoming event in the diary.

36. The computer system of claim 35, wherein the reminder is issued further based on the clash event notification function determining that there will not be time for the user to get from the user's current position to the location of the upcoming event in the dairy.

37. The computer system of claim 30, further comprising a typing prediction function which predicts potential events and up to three other types of results as search terms are input by a user at the user terminal wherein the predicted potential events and predicted the results are displayed in a modal window separated under up to four headings.

38-39. (canceled)

40. The computer system of claim 37, wherein the predicted potential events are displayed in the modal window under the heading “Events” and the predicted results are displayed in the modal window under at least one of the following headings, based on the type of result: “Venues”, “Categories” and “Microsites”.

41. (canceled)

42. The user device of claim 43,
wherein the user interface display of a user selectable “add” button comprises the user interface being configured to display said user selectable “add” button when the user performs a side-swipe action on information for one event presented on the user-interface.

43. A user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user a log in area for identifying a user and event information based on the event data for the selected date so as to permit the logged in user to select at least one event for populating the user diary, whereby selection of the event by the user automatically imports the event to the diary, by updating stored diary data;
wherein the user interface enables the user to enter a search parameter and wherein the event data is received as a group of events sharing a common criteria defined by the search parameter, the user interface configured to display the group as a stack wherein a single image is visible with a user selectable icon for selecting the display of all the events in the group;
wherein the user interface displays on a screen a user selectable “add” button for each of the displayed events in the group, any one or more of the “add” buttons being selectable by the user so as to select one or more of the corresponding events in the group; and
a user selectable “add selected events” button is then selectable by the user so as to simultaneously add the selected events in the group to the user diary.

44. The user device of claim 43, further comprising:
a geo-location device for automatically locating the user; and
wherein the user interface displays event information for events that are nearest to the user's current position.

45. The user device of claim 46, wherein the event information displays comprises
event information for events that are within a pre-defined radius of the user's current position.

46. The user device of claim 44,
wherein the event information displays for each event how far away the respective event location is from the user's current position.

47-52. (canceled)

53. A computer system for managing event data, comprising:
a database storing event data relating to a plurality of events;
a diary function receiving a calendar selection message from a user terminal, the calendar selection message including at least a user identifier and selection information for subscribing to a themed calendar for said user;
wherein the diary function stores a user diary associated with the user, and the user identifier allocates the calendar selection message to the user diary associated with the user; and
based on event data from the database, an update function populating the user diary with events corresponding to a class of events associated with the themed calendar the user has subscribed to.

54. The computer system of claim 53, further comprising a media server for transmitting to the user terminal media content associated with the themed calendar the user has subscribed to.

55. The computer system according to claim 53, wherein the event data being stored in the database comprises an update function for addition of new event data and/or changed event data.

56. The computer system of claim 55, wherein the update function is configured to, based on the new and/or changed event data, add to the user diary new and/or changed events corresponding to the class of events associated with the themed calendar the user has subscribed to.
